(19) United States
(12) Patent Application Publication
(10) Pub. No.: US 2013/0295472 A1
(43) Pub. Date: Nov. 7, 2013

(54) METAL-AIR BATTERY

(71) Applicant: Masanobu AIZAWA, Osaka (JP)

(72) Inventor: Masanobu AIZAWA, Osaka (JP)

(21) Appl. No.: 13/934,510

(22) Filed: Jul. 3, 2013

Related U.S. Application Data
(62) Division of application No. 13/700,253, filed on Nov. 27, 2012.

(30) Foreign Application Priority Data
Jun. 4, 2010 (JP) P2010-128796
Nov. 8, 2010 (JP) P2010-249938
Mar. 29, 2011 (JP) P2011-071500

(51) Int. Cl. H01M 8/22

(52) U.S. Cl. CPC H01M 8/22
USPC 429/405

(57) ABSTRACT

A metal-air battery is a secondary battery that includes a positive electrode, a negative electrode, an electrolyte layer, and an air introduction pipe. The positive electrode is a porous member having a substantially cylindrical bottomed shape and includes a positive electrode supporter made of alumina, a positive electrode conductive layer made of a perovskite type oxide having electrical conductivity, and a positive electrode catalyst layer made of manganese dioxide. The negative electrode includes a negative electrode supporter made of stainless steel and a negative electrode conductive layer made of lithium or a lithium alloy. The metal-air battery can realize the positive electrode that contains no carbon by forming the positive electrode catalyst layer on the positive electrode conductive layer made of a perovskite type oxide. This enables prevention of the generation of lithium carbonate on the positive electrode during discharge, thus reducing the charge voltage of the metal-air battery.

### TECHNICAL FIELD

The present invention relates to a metal-air battery.

### BACKGROUND ART

Conventionally, metal-air batteries that use metals as active materials of their negative electrodes and the oxygen in the air as active materials of their positive electrodes are known. For example, Japanese Patent Application Laid-Open No. 2008-66202 (Document 1) proposes a metal-air battery in which an electrolyte-containing layer is provided between the positive electrode and the negative electrode, wherein an electrolyte of the layer contains ionic liquids, inorganic fine particles, and an electrolyte salt. Japanese Patent Application Laid-Open No. 2009-230981 (Document 2) proposes a metal-air battery in which a positive electrode and a negative electrode are disposed in a non-aqueous electrolyte solution and that is provided with an oxygen pump that supplies the oxygen in the air to the positive electrode via an oxygen-ion conducting solid electrolyte.

In the lithium-air secondary battery disclosed in Japanese Patent Application Laid-Open No. 2008-112724 (Document 3), the positive electrode contains a positive electrode catalyst having a function of absorbing and desorbing oxygen, a carbon material, and an organic binder (e.g., carbon fiber), and the negative electrode is formed of lithium in the form of a plate. Examples of the positive electrode catalyst that is used include manganese dioxide (MnO₂) and perovskite type oxides. In the lithium-air secondary battery disclosed in Japanese Patent Application Laid-Open No. 2009-283381 (Document 4), the positive electrode is a gas diffusion oxygen electrode made primarily of carbon (C), and the negative electrode is formed from a substance capable of absorbing and desorbing a lithium metal or lithium ions. The positive electrode also contains 20 to 60% by weight of an iron (Fe)-based oxide having a perovskite structure.

Metal-air batteries have a risk of a short circuit occurring between their positive and negative electrodes due to local deposition of metals on the negative electrodes during charge. In view of this, techniques for preventing a short circuit between positive and negative electrodes by providing a separator therebetween have been proposed (see Documents 1 and 2, for example).

Incidentally, in the metal-air batteries disclosed in Documents 1 to 4, because the positive electrodes contain carbon as a conductive substance, lithium carbonate (Li₂CO₃) or the like that is a carbonate salt of a metal in the negative electrodes is deposited on the positive electrodes during discharge. These metal-air batteries require a large amount of energy in order to electrolyze and ionize the lithium carbonate during charge, thus having an increased charge voltage.

The metal-air batteries also have a risk that the electrolyte solution may permeate through and leak out of the positive electrodes because the positive electrodes are porous members. The leakage of the electrolyte solution will considerably reduce battery performance (e.g., battery capacity).

It is also conceivable that a metal-air battery is provided with an auxiliary electrode (i.e., third electrode) for charging, and the charge/discharge performance of the metal-air battery is enhanced by using the positive electrode and the negative electrode during discharge and using the negative electrode and the auxiliary electrode during charge. However, even such a metal-air battery has a risk of a short circuit occurring between the negative electrode and the auxiliary electrode due to local deposition of metals on the negative electrode during charge.

### SUMMARY OF INVENTION

The present invention is intended for a metal-air battery, and it is a primary object of the present invention to prevent generation of a metal carbonate on a positive electrode during discharge. Other objects of the present invention are to prevent permeation and leakage of an electrolyte solution into and from the positive electrode and to prevent the occurrence of a short circuit between a negative electrode and an auxiliary electrode.

According to a preferable aspect of the present invention, the metal-air battery includes a negative electrode that contains a metal and generates metal ions during discharge, a porous positive electrode that contains a perovskite type oxide having electrical conductivity and a catalyst that accelerates an oxygen reduction reaction but no carbon and that generates oxygen ions during discharge, and an electrolyte layer disposed between the negative electrode and the positive electrode. Accordingly, it is possible to prevent generation of a metal carbonate on the positive electrode during discharge.

The positive electrode preferably includes a supporter, a conductive film of the perovskite type oxide formed on the supporter, and a catalyst layer of the catalyst formed on the conductive film.

More preferably, the metal-air battery further includes a liquid repellent layer provided in the positive electrode and having liquid repellency to an electrolyte solution of the electrolyte layer. Accordingly, it is possible to prevent permeation and leakage of the electrolyte solution into and from the positive electrode.

According to another preferable aspect of the present invention, the metal-air battery includes a negative electrode layer that contains a metal and generates metal ions during discharge, a porous positive electrode layer that contains a conductive material and a catalyst and generates oxygen ions during discharge, the catalyst accelerating an oxygen reduction reaction, a first electrolyte layer disposed between the negative electrode layer and the positive electrode layer, an auxiliary electrode layer having a surface that faces a surface of the negative electrode layer opposite to the positive electrode layer, and a second electrolyte layer that is disposed between the negative electrode layer and the auxiliary electrode layer and communicates with the first electrolyte layer. The surface of the negative electrode layer has a portion extending outwardly from a portion facing an edge of the surface of the auxiliary electrode layer, and the metal is deposited on the negative electrode layer by application of a voltage between the negative electrode layer and the auxiliary electrode layer during charge. Accordingly, it is possible to prevent the occurrence of a short circuit between the negative electrode layer and the auxiliary electrode layer.

More preferably, the positive electrode layer, the negative electrode layer, and the auxiliary electrode layer are cylindrical, the positive electrode layer is disposed on an inner side of the negative electrode layer and the auxiliary electrode layer is disposed on an outer side of the negative electrode layer.

In the case where the conductive material is a perovskite type oxide, and the positive electrode layer contains no carbon, it is possible to prevent generation of a metal carbonate on the positive electrode layer during discharge.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a longitudinal cross-sectional view of a metal-air battery according to a first embodiment;

FIG. 2 is a transverse cross-sectional view of the metal-air battery;

FIG. 3 is a longitudinal cross-sectional view of a metal-air battery according to a second embodiment;

FIG. 4 is a transverse cross-sectional view of the metal-air battery;

FIG. 5 is a transverse cross-sectional view of a metal-air battery according to a third embodiment;

FIG. 6 is a transverse cross-sectional view of a metal-air battery according to a fourth embodiment;

FIG. 7 is a longitudinal cross-sectional view of a metal-air battery according to a fifth embodiment;

FIG. 8 is a longitudinal cross-sectional view of a metal-air battery according to a sixth embodiment;

FIG. 9 is a transverse cross-sectional view of the metal-air battery;

FIG. 10 is transverse cross-sectional view of another example of the metal-air battery;

FIG. 11 is a longitudinal cross-sectional view of a metal-air battery according to a seventh embodiment;

FIG. 12 is a transverse cross-sectional view of the metal-air battery;

FIG. 13 is a transverse cross-sectional view of a metal-air battery according to an eighth embodiment;

FIG. 14 is a transverse cross-sectional view of a metal-air battery according to a ninth embodiment;

FIG. 15 is a longitudinal cross-sectional view of a metal-air battery according to a tenth embodiment;

FIG. 16 is a longitudinal cross-sectional view of a metal-air battery according to an eleventh embodiment;

FIG. 17 is a transverse cross-sectional view of the metal-air battery;

FIG. 18.A shows a negative electrode layer and an auxiliary electrode layer in a metal-air battery according to a comparative example;

FIG. 18.B shows a negative electrode layer and an auxiliary electrode layer in a metal-air battery according to another comparative example; and

FIG. 19 shows a negative electrode layer and an auxiliary electrode layer.

### DESCRIPTION OF EMBODIMENTS

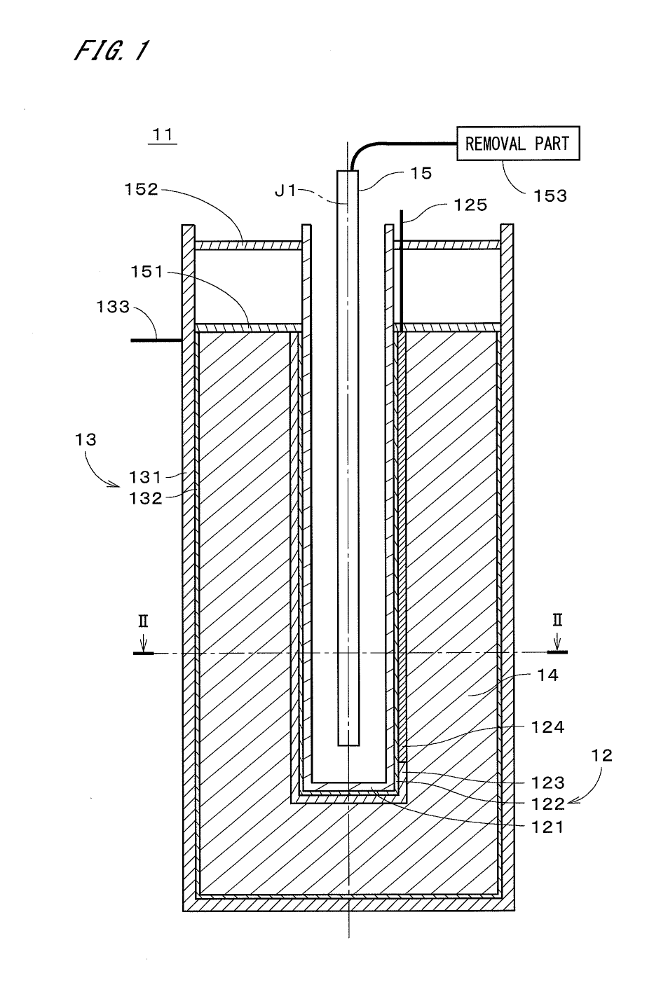

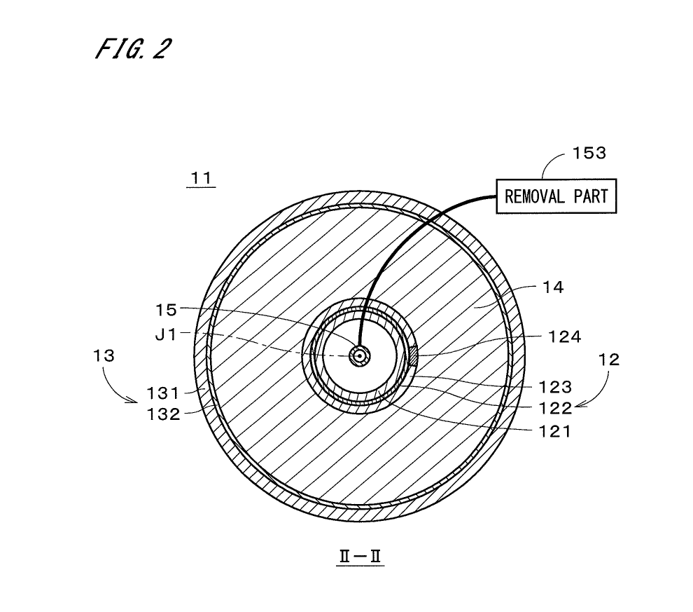

FIG. 1 is a longitudinal cross-sectional view of a metal-air battery 11 according to a first embodiment of the present invention. The metal-air battery 11 has a substantially cylindrical shape, and a cross section of the metal-air battery 11 including a central axis J1 thereof is shown in FIG. 1. FIG. 2 is a transverse cross-sectional view of the metal-air battery 11 taken along line II-II in FIG. 1. As shown in FIGS. 1 and 2, the metal-air battery 11 is a secondary battery that includes a positive electrode 12, a negative electrode 13, an electrolyte layer 14, and an air introduction pipe 15. The air introduction pipe 15, the positive electrode 12, the electrolyte layer 14, and the negative electrode 13 are concentrically disposed in this order from the central axis J1 toward the outside in the radial direction. In other words, the metal-air battery 11 has a substantially cylindrical shape in which the negative electrode 13 is disposed along its outer periphery and the positive electrode 12 is disposed along its inner periphery.

The positive electrode 12 is a porous member having a substantially cylindrical bottomed shape and includes a positive electrode supporter 121, a positive electrode conductive layer 122, and a positive electrode catalyst layer 123, each of which has a substantially cylindrical bottomed shape. The positive electrode conductive layer 122 is laminated on the outer side and bottom faces of the positive electrode supporter 121, and the positive electrode catalyst layer 123 is laminated on the outer side and bottom faces of the positive electrode conductive layer 122. The positive electrode 12 is provided with a positive electrode current collector 124 on a part of the outer side face of the positive electrode conductive layer 122 so as to replace the positive electrode catalyst layer 123, and as shown in FIG. 1, a positive electrode current collector terminal 125 is connected to the upper end of the positive electrode current collector 124. The positive electrode 12 and the positive electrode current collector 124 contain no carbon (C).

The positive electrode supporter 121 is a porous member formed of alumina (aluminum oxide: Al₂O₃), zirconia, ceramic, or metals such as stainless steel. In the present embodiment, the positive electrode supporter 121 is formed of alumina that is an insulator. The formation of the positive electrode supporter 121 is carried out by extrusion molding, cold isostatic pressing (CIP) and firing, hot isostatic pressing (HIP), or the like.

The positive electrode conductive layer 122 is a thin porous conductive film formed primarily of a perovskite type oxide having electrical conductivity (normally in the form of powder), and preferably, a perovskite type oxide represented by the chemical formula A₁₋ₓBO₃ (0.9≦1−x<1.0). In the present embodiment, the positive electrode conductive layer 122 is formed of a lanthanum perovskite type oxide (specifically, perovskite type oxide containing lanthanum in the A-site such as lanthanum strontium manganite (LSM: La(Sr)MnO₃) or lanthanum strontium cobaltite (LSC: La(Sr)CoO₃). The formation of the positive electrode conductive layer 122 is carried out by a slurry coating method, a hydrothermal synthesis method, chemical vapor deposition (CVD), physical vapor deposition (PVD), or the like.

The positive electrode catalyst layer 123 is a porous member formed primarily of metal oxides serving as a catalyst that accelerates oxygen reduction reactions, such as manganese (Mn), nickel (Ni), or cobalt (Co). The positive electrode catalyst layer 123 may be formed of precious metals such as platinum (Pt), palladium (Pd), silver (Ag), rhodium (Rh), and ruthenium (Ru), or a mixture of these precious metals and the aforementioned metal oxides. In the present embodiment, the positive electrode catalyst layer 123 is formed of manganese dioxide (MnO₂) having a β (rutile) crystal structure. The formation of the positive electrode catalyst layer 123 is carried out by a slurry coating method and firing, a hydrothermal synthesis method, CVD, PVD, or the like.

As shown in FIGS. 1 and 2, the negative electrode 13 includes a negative electrode supporter 131 having a substantially cylindrical bottomed shape and a negative electrode conductive layer 132 having a substantially cylindrical bottomed shape and laminated on the inner side and bottom faces of the negative electrode supporter 131. The negative electrode supporter 131 is a negative electrode current collector formed of a conductive material such as metals (in the present embodiment, stainless steel), and as shown in FIG. 1, a negative electrode current collector terminal 133 is provided on the outer side face of the negative electrode supporter 131. The negative electrode conductive layer 132 is a thin conductive film formed of metals such as lithium (Li) or zinc (Zn) or an alloy containing such metals. In the present embodiment, the negative electrode conductive layer 132 is formed of lithium or a lithium alloy. The formation of the negative electrode conductive layer 132 is carried out by a slurry coating method, for example.

The electrolyte layer 14 is formed of a non-aqueous electrolyte. In the present embodiment, the electrolyte layer 14 is formed by charging (disposing) an organic solvent electrolyte solution between the positive electrode 12 and the negative electrode 13. The electrolyte layer 14 is in contact with the positive electrode catalyst layer 123 and the positive electrode current collector 124 of the positive electrode 12 and the negative electrode conductive layer 132 of the negative electrode 13. The upper face of the electrolyte layer 14 is closed with a substantially annular inner lid 151 that is in contact with the outer side face of the positive electrode supporter 121 and the inner side face of the negative electrode supporter 131, and a top lid 152 of the same shape as the inner lid 151 is provided above the inner lid 151 so as to close an upper opening of the negative electrode 13 having a substantially cylindrical bottomed shape.

The air introduction pipe 15 is disposed on the inner side of the positive electrode 12 having a substantially cylindrical bottomed shape, and the lower end of the air introduction pipe 15 is positioned in the vicinity of the bottom of the positive electrode supporter 121 of the positive electrode 12. The upper end of the air introduction pipe 15 is connected to a removal part 153 that removes moisture and carbon dioxide from the air. The removal part 153 removes the moisture and carbon dioxide in the air by membrance separation or by adsorption. The air from the removal part 153 (i.e., the air from which moisture and carbon dioxide have been removed) is led by the air introduction pipe 15 to the vicinity of the bottom on the inner side of the positive electrode 12, then goes up along the inner side face of the positive electrode 12 while being supplied to the positive electrode 12, and is exhausted from the upper opening of the positive electrode 12 to the outside. In the metal-air battery 11, the air introduction pipe 15 serves as a gas supply part that supplies the air from the removal part 153 to the positive electrode 12. The air supplied to the positive electrode 12 passes through the positive electrode supporter 121 and the positive electrode conductive layer 122, each of which is a porous member, and is supplied to the positive electrode catalyst layer 123.

During discharge of the metal-air battery 11, the negative electrode current collector terminal 133 and the positive electrode current collector terminal 125 are electrically connected to each other via a load (e.g., lighting equipment). In the negative electrode 13, lithium contained in the negative electrode conductive layer 132 is oxidized into lithium ions (Li⁺), and electrons are supplied to the positive electrode 12 via the negative electrode current collector terminal 133, the positive electrode current collector 124, and the positive electrode current collector terminal 125. In the positive electrode 12, the oxygen in the air supplied by the air introduction pipe 15 is reduced into oxygen ions (O²⁻) by the electrons supplied from the negative electrode 13. Because the generation of oxygen ions (i.e., reduction reaction of oxygen) in the positive electrode 12 is accelerated by the positive electrode catalyst contained in the positive electrode catalyst layer 123, an overvoltage due to energy consumption during the reduction reaction decreases and thus it is possible to increase the discharge voltage of the metal-air battery 11. The oxygen ions generated in the positive electrode 12 bind to the lithium ions dissolved from the negative electrode 13 into the electrolyte layer 14, thereby giving lithium oxide (Li₂O).

During charge of the metal-air battery 11, a voltage is applied between the negative electrode current collector terminal 133 and the positive electrode current collector terminal 125. In the positive electrode 12, lithium oxide is decomposed, and electrons from the oxygen ions are supplied to the positive electrode current collector terminal 125 via the positive electrode current collector 124, generating oxygen. In the negative electrode 13, lithium ions are reduced by the electrons supplied to the negative electrode current collector terminal 133, and lithium is deposited on the surface of the negative electrode conductive layer 132. Because the generation of oxygen in the positive electrode 12 is accelerated by the positive electrode catalyst contained in the positive electrode catalyst layer 123, an overvoltage decreases and thus it is possible to reduce the charge voltage of the metal-air battery 11.

By the way, the positive electrodes of ordinary metal-air batteries are primarily made of carbon for obtaining conductivity, and positive electrode catalysts that accelerate reduction reactions of oxygen are added to the carbon. However, such metal-air batteries will have increased charge voltages because lithium ions generated during discharge are deposited as lithium carbonate (Li₂CO₃) on the positive electrodes, and a large amount of energy is required in order to electrolyze and ionize the lithium carbonate during charge.

In contrast, the metal-air battery 11 according to the present embodiment can realize the positive electrode 12 that contains no carbon by forming the positive electrode catalyst layer 123 on the positive electrode conductive layer 122 formed of a perovskite type oxide. As a result, it is possible to prevent the generation of lithium carbonate on the positive electrode 12 during discharge and to thereby reduce the charge voltage of the metal-air battery 11. Also, the discharge voltage of the metal-air battery 11 can be increased because the positive electrode conductive layer 122 contains a highly conductive lanthanum perovskite type oxide. Furthermore, by using a perovskite type oxide represented by the chemical formula A₁₋ₓBO₃ (0.9≦1−x<1.0) as the perovskite type oxide contained in the positive electrode conductive layer 122, it is possible to prevent deterioration in the positive electrode conductive layer 122 due to moisture and to thereby improve the durability of the metal-air battery 11.

The metal-air battery 11 can reduce the amount of usage of a relatively expensive perovskite type oxide because the positive electrode conductive layer 122 of the positive electrode 12 is a thin conductive film supported (carried) by the positive electrode supporter 121. This results in a reduction in the manufacturing cost of the metal-air battery 11. Furthermore, because the negative electrode 13 contains lithium or a lithium alloy having a high theoretical voltage and a high electrochemical equivalent, the capacity of the metal-air battery 11 can be increased.

As described above, since the metal-air battery 11 has a cylindrical shape in which the negative electrode 13 is disposed along its outer periphery and the positive electrode 12 is disposed along its inner periphery, even if upsizing of the metal-air battery 11 is required, thin film layers such as the negative electrode conductive layer 132 and the positive electrode conductive layer 122 can be readily formed. In other words, it is easy to cope with the upsizing of the metal-air battery 11. Furthermore, the supply of the air from which moisture and carbon dioxide have been removed, to the positive electrode 12 through the air introduction pipe 15 prevents the occurrence of a reaction between the carbon dioxide in the air and the lithium ions and subsequent adherence of lithium carbonate to the positive electrode 12, and prevents the occurrence of a reaction between the moisture and the lithium contained in the negative electrode conductive layer 132 of the negative electrode 13 and subsequent deterioration in the negative electrode conductive layer 132.

In the metal-air battery 11, inorganic fine particles (filler) may be added to the non-aqueous electrolyte solution of the electrolyte layer 14. The inorganic fine particles are preferably made of inorganic oxides such as alumina, silicon dioxide (SiO₂), titanium dioxide (TiO₂), zeolite, and perovskite type oxides, and in particular, zeolite particles having a high silicon content (e.g., the ratio of Si to Al is 2 or higher) are more preferable. Containing inorganic fine particles in the electrolyte solution of the electrolyte layer 14 reduces the internal resistance of the metal-air battery 11 and increases the battery capacity, and also prevents liquid leakage from the metal-air battery 11. Note that the metal-air batteries according to the following embodiments can also achieve the same effects as described above (i.e., an increase in the battery capacity and prevention of liquid leakage) by containing inorganic fine particles in a non-aqueous electrolyte solution contained in a first electrolyte layer 14, which will be described later.

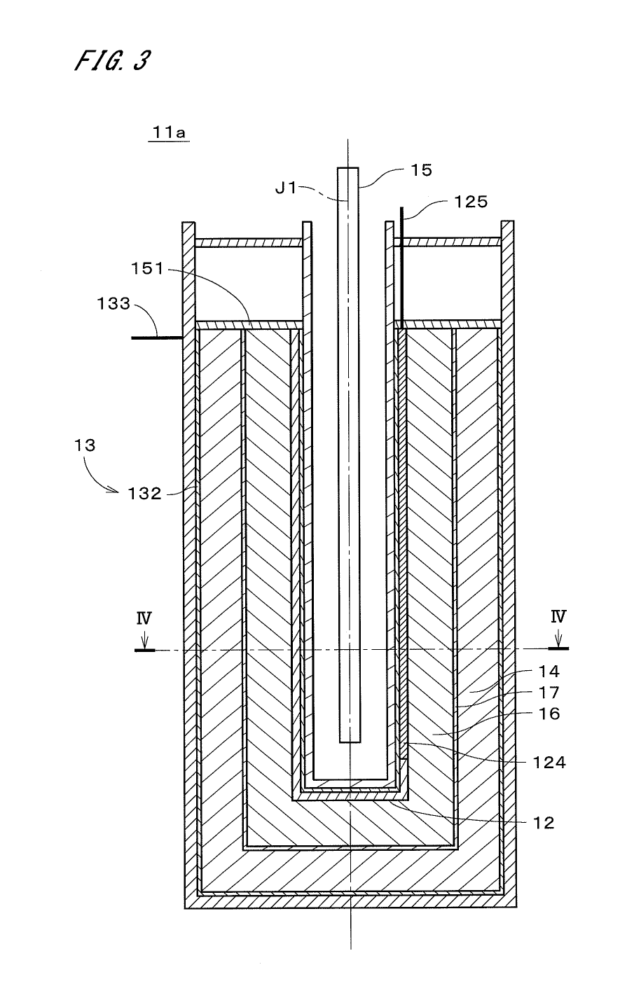

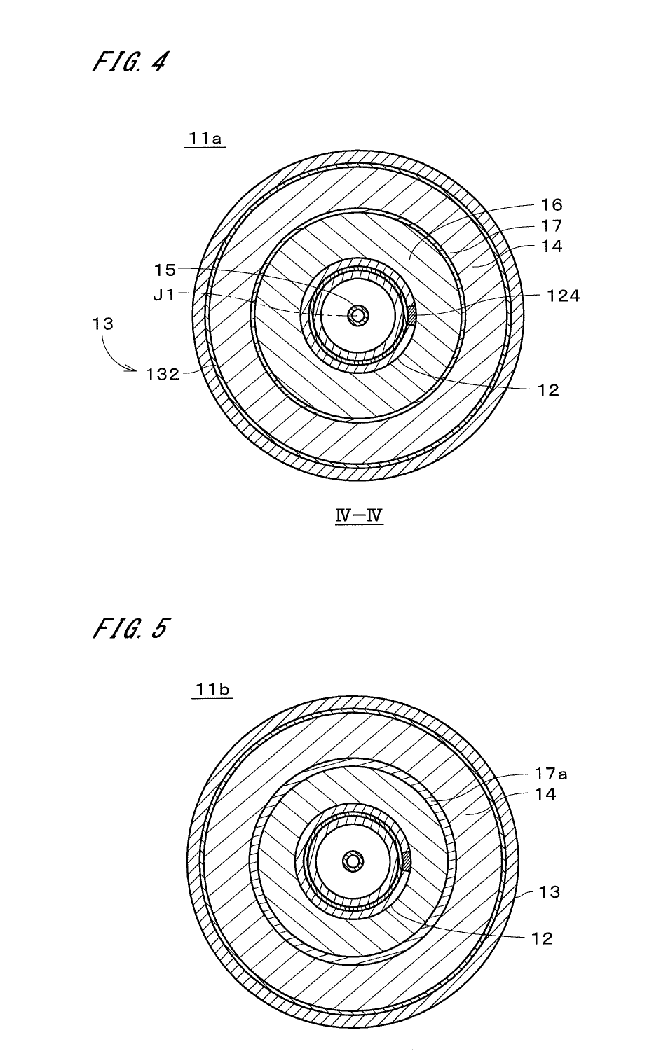

Next is a description of a metal-air battery according to a second embodiment of the present invention. FIGS. 3 and 4 are respectively a longitudinal cross-sectional view and a transverse cross-sectional view of a metal-air battery 11a according to the second embodiment. FIG. 4 is a cross-sectional view of the metal-air battery 11a taken along line IV-IV in FIG. 3. For the sake of simplicity of the drawings, illustration of a removal part 153 has been omitted in FIGS. 3 and 4 (the same applies to FIGS. 5 to 7).

In the metal-air battery 11a, another electrolyte layer 16 is disposed between an electrolyte layer 14 and a positive electrode 12, and a barrier layer 17 is disposed between the electrolyte layer 14 and the electrolyte layer 16. The barrier layer 17 is a thin-film solid electrolyte and allows only lithium ions to selectively pass therethrough. The other constituent elements are the same as those of the metal-air battery 11 shown in FIGS. 1 and 2, and in the following description, corresponding constituent elements are denoted by the same reference numerals. In order to distinguish between the two electrolyte layers 14 and 16, the electrolyte layer 14 and the electrolyte layer 16 are respectively referred to as a “first electrolyte layer 14” and a “second electrolyte layer 16”.

As shown in FIGS. 3 and 4, the second electrolyte layer 16 has a substantially cylindrical bottomed shape with a central axis J1 at the center and is in contact with the positive electrode 12. The barrier layer 17 also has a substantially cylindrical bottomed shape and is in contact with the first electrolyte layer 14 and the second electrolyte layer 16. The second electrolyte layer 16 is formed by charging (disposing) an aqueous electrolyte solution between the positive electrode 12 and the barrier layer 17. Like the upper face of the first electrolyte layer 14, the upper face of the second electrolyte layer 16 is closed with a substantially annular inner lid 151 (shown in only FIG. 3). In the present embodiment, the first electrolyte layer 14 is a porous polymer that is impregnated with a non-aqueous (e.g., organic solvent) electrolyte solution, and the barrier layer 17 that is a thin-film solid electrolyte is supported (carried) on the inner side and bottom faces of the first electrolyte layer 14 by the first electrolyte layer 14. In other words, the first electrolyte layer 14 also serves as a barrier supporting layer that supports the barrier layer 17. One example of the barrier layer 17 that is used is glass ceramics (LTAP) represented by the chemical formula Li_{1+x+y}Ti₂₋ₓAlₓP_{3-y}Si_{y}O₁₂.

During discharge of the metal-air battery 11a, lithium contained in the negative electrode conductive layer 132 of the negative electrode 13 is oxidized into lithium ions, and electrons are supplied to the positive electrode 12 via the negative electrode current collector terminal 133, the positive electrode current collector 124, and the positive electrode current collector terminal 125. The negative electrode current collector terminal 133 and the positive electrode current collector terminal 125 are shown in only FIG. 3. In the positive electrode 12, the oxygen in the air supplied through the air introduction pipe 15 is reduced into oxygen ions by the electrons supplied from the negative electrode 13, and the oxygen ions react with the water contained in the second electrolyte layer 16 and turn into hydroxide ions (OH⁻). The hydroxide ions bind to the lithium ions that have been dissolved from the negative electrode 13 into the electrolyte layer 14, thereby giving lithium hydroxide (LiOH). Since lithium hydroxide is water-soluble, it dissolves in the aqueous electrolyte solution of the second electrolyte layer 16.

During charge of the metal-air battery 11a, a voltage is applied between the negative electrode current collector terminal 133 and the positive electrode current collector terminal 125. In the positive electrode 12, electrons from the hydroxide ions are supplied to the positive electrode current collector terminal 125, generating water and oxygen. In the negative electrode 13, lithium ions are reduced by the electrons supplied to the negative electrode current collector terminal 133, and lithium is deposited on the surface of the negative electrode conductive layer 132.

Since, as in the first embodiment, the positive electrode 12 of the metal-air battery 11a contains no carbon, it is possible to prevent the generation of lithium carbonate on the positive electrode 12 during discharge and to thereby reduce the charge voltage of the metal-air battery 11a. In particular, providing the barrier layer 17 between the positive electrode 12 and the negative electrode 13 in the metal-air battery 11a suppresses, when lithium is deposited in dendritic form on the negative electrode 13 during charge, the growth of deposited dendritic portions (so-called dendrites) toward the positive electrode 12. As a result, it is possible to prevent dendrites from reaching the positive electrode 12 and causing a short circuit. Furthermore, supporting the barrier layer 17 by the first electrolyte layer 14 facilitates installation of the thin film barrier layer 17, resulting in downsizing of the metal-air battery 11a. Moreover, since the barrier layer 17 is in the form of a thin film, ionic conductivity is increased more than when the barrier layer 17 is formed thick.

Next is a description of a metal-air battery according to a third embodiment of the present invention. FIG. 5 is a transverse cross-sectional view of a metal-air battery 11b according to the third embodiment. In the metal-air battery 11b, a barrier layer 17a that serves as a separator is provided instead of the barrier layer 17 (solid electrolyte) of the metal-air battery 11a shown in FIGS. 3 and 4. The other constituent elements are the same as those of the metal-air battery 11a shown in FIGS. 3 and 4, and in the following description, corresponding constituent elements are denoted by the same reference numerals.

The barrier layer 17a is a porous member formed of ceramics, metals, inorganic materials, organic materials, or the like and holds an electrolyte in its pores, the electrolyte allowing lithium ions to selectively pass therethrough. The formation of the barrier layer 17a is carried out by extrusion molding, CIP and firing, HIP, or the like. Reactions during the charge and discharge of the metal-air battery 11b are the same as those of the metal-air battery 11a according to the second embodiment.

Since the positive electrode 12 of the metal-air battery 11b contains no carbon as in the first and second embodiments, it is possible to prevent the generation of lithium carbonate on the positive electrode 12 during discharge and to thereby reduce the charge voltage of the metal-air battery 11b. Furthermore, providing the barrier layer 17a between the positive electrode 12 and the negative electrode 13 makes it possible to suppress the growth of dendrites on the negative electrode 13 during charge, thus preventing the occurrence of a short circuit as in the second embodiment. In particular, since the installation of the barrier layer 17a serving as a separator does not require the support of the first electrolyte layer 14, the metal-air battery 11b can have a higher degree of freedom in selecting the material for the first electrolyte layer 14.

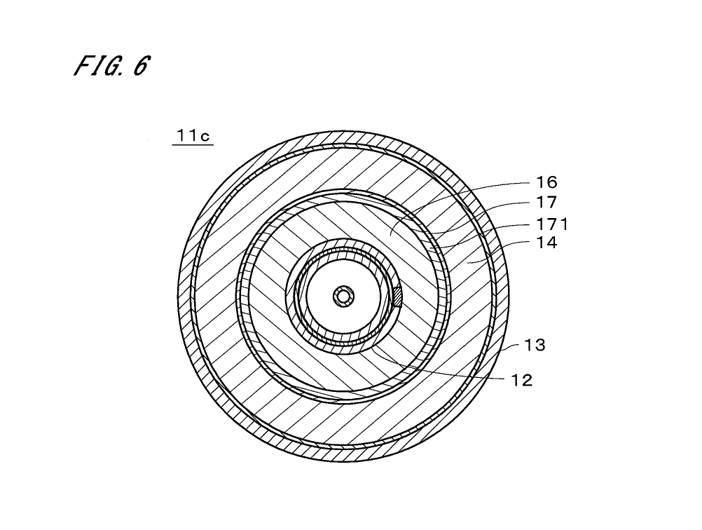

Next is a description of a metal-air battery according to a fourth embodiment of the present invention. FIG. 6 is a transverse cross-sectional view of a metal-air battery 11 c according to the fourth embodiment. The metal-air battery 11c has the same configuration as the metal-air battery 11a shown in FIGS. 3 and 4, with the exception that a barrier supporting layer 171 is provided between a second electrolyte layer 16 and a barrier layer 17. In the following description, corresponding constituent elements are denoted by the same reference numerals.

The barrier supporting layer 171 is a porous member that is formed of ceramics, metals, inorganic materials, organic materials, or the like by a method such as extrusion molding, CIP and firing, or HIP, and pores of the barrier supporting layer 171 are impregnated with an aqueous electrolyte solution of the second electrolyte layer 16. The barrier layer 17 that is a thin-film solid electrolyte is supported (carried) on the outer side and bottom faces of the barrier supporting layer 171 by the barrier supporting layer 171. Reactions during the charge and discharge of the metal-air battery 11c are the same as those of the metal-air battery 11a according to the second embodiment.

Since the positive electrode 12 of the metal-air battery 11c contains no carbon as in the first to third embodiments, it is possible to prevent the generation of lithium carbonate on the positive electrode 12 during discharge and to thereby reduce the charge voltage of the metal-air battery 11c. Furthermore, providing the barrier layer 17 and the barrier supporting layer 171 between the positive electrode 12 and the negative electrode 13 makes it possible to suppress the growth of dendrites on the negative electrode 13 during charge, thus preventing the occurrence of a short circuit as in the second embodiment. Since, as described above, the barrier layer 17 is supported by the barrier supporting layer 171 and does not require the support of the first electrolyte layer 14, the metal-air battery 11c can have a higher degree of freedom in selecting the material for the first electrolyte layer 14.

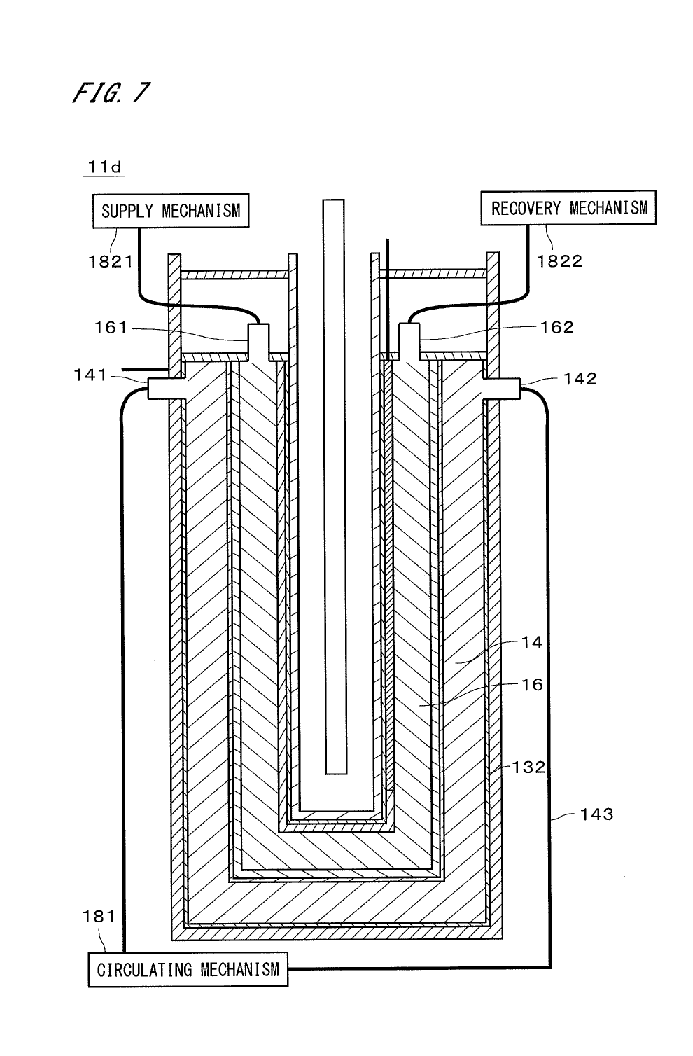

Next is a description of a metal-air battery according to a fifth embodiment of the present invention. FIG. 7 is a longitudinal cross-sectional view of a metal-air battery 11d according to the fifth embodiment. The metal-air battery 11d has the same configuration as the metal-air battery 11c shown in FIG. 6, with the exception that a first electrolyte layer 14 is connected to a circulating mechanism 181 for circulating a non-aqueous electrolyte solution of the first electrolyte layer 14 and that the second electrolyte layer 16 is connected to an exchange mechanism for exchanging an aqueous electrolyte solution of the second electrolyte layer 16. In the following description, corresponding constituent elements are denoted by the same reference numerals.

As shown in FIG. 7, a supply port 141 from which an electrolyte solution is supplied to the first electrolyte layer 14 and a discharge port 142 from which the electrolyte solution of the first electrolyte layer 14 is discharged are formed on the side portion of the metal-air battery 11d. The supply port 141 and the discharge port 142 are connected to the circulating mechanism 181 via a pipeline 143, and the electrolyte solution discharged from the discharge port 142 passes through the circulating mechanism 181 and is supplied again to the first electrolyte layer 14 from the supply port 141. This produces the flow of the electrolyte solution inside the first electrolyte layer 14 and suppresses the generation and growth of dendrites during the charge of the metal-air battery 11d. The circulating mechanism 181 is also provided with a filter so that in the case where thin pieces of lithium fall off from the negative electrode conductive layer 132 during charge or the like, these pieces of lithium will be recovered by the circulating mechanism 181.

The metal-air battery 11d is also provided with a supply port 161 from which an electrolyte solution is supplied to the second electrolyte layer 16 and a discharge port 162 from which the electrolyte solution of the second electrolyte layer 16 is discharged. The supply port 161 is connected to a supply mechanism 1821 of the aforementioned exchange mechanism, and a new electrolyte solution is supplied from the supply mechanism 1821 to the second electrolyte layer 16. The discharge port 162 is connected to a recovery mechanism 1822 of the exchange mechanism, and the electrolyte solution discharged from the second electrolyte layer 16 is recovered by the recovery mechanism 1822. This prevents the electrolyte solution of the second electrolyte layer 16 from being saturated with lithium hydroxide during the discharge of the metal-air battery 11d, thus increasing the discharge duration of the metal-air battery 11d. Lithium is recovered from the electrolyte solution recovered by the recovery mechanism 1822. The recovered lithium may be reused as a negative electrode conductive layer 132 of the metal-air battery.

While the above has been a description of the first to fifth embodiments of the present invention, the above-described embodiments can be modified in various ways.

In the negative electrode 13, the negative electrode supporter 131 does not necessarily have to be formed of a conductive material. In the case where the negative electrode supporter 131 is formed of an insulator, the negative electrode current collector terminal 133 penetrates through the negative electrode supporter 131 and is electrically connected to the negative electrode conductive layer 132. Also, the negative electrode supporter 131 does not necessarily have to be provided, and the entire negative electrode 13 may be formed of lithium or a lithium alloy. It is sufficient for the negative electrode conductive layer 132 to be formed of various materials including metals that are oxidized into metal ions during discharge.

In the positive electrode 12, in the case where the positive electrode supporter 121 is formed of a conductive material, the positive electrode current collector 124 may be omitted and the positive electrode current collector terminal 125 may be provided on the inner side face of the positive electrode supporter 121. In the case where the positive electrode conductive layer 122 has a certain degree of thickness, the positive electrode supporter 121 that supports the positive electrode conductive layer 122 may be omitted. In this case, the positive electrode current collector terminal 125 is provided on the inner side face of the positive electrode conductive layer 122.

In the metal-air batteries, the positive electrode 12 may be configured by forming a conductive layer from a mixture of the material for the positive electrode supporter 121 and the material for the positive electrode conductive layer 122 (i.e., perovskite type oxide) and forming the positive electrode catalyst layer 123 on that conductive layer. Alternatively, the positive electrode 12 may be formed from a mixture of the material for the positive electrode supporter 121, the material for the positive electrode conductive layer 122, and the material for the positive electrode catalyst layer 123. In either case, the positive electrode 12 contains a perovskite type oxide having electrical conductivity and a catalyst that accelerates oxygen reduction reactions, but no carbon. Thus, it is possible to prevent the generation of a carbonate salt of the metal contained in the negative electrode 13 on the positive electrode 12 during the discharge of the metal-air batteries.

In the metal-air battery 11 according to the first embodiment, it is sufficient for the electrolyte layer 14 to be formed of a non-aqueous electrolyte, and for example, the electrolyte layer 14 may be formed of a solid electrolyte. In the case where the electrolyte layer 14 is formed of a solid electrolyte, the generation and growth of dendrites can be suppressed. Also, in the metal-air batteries according to the second to fourth embodiments, the second electrolyte layer 16 may be formed of a non-aqueous electrolyte (i.e., non-aqueous electrolyte solution or solid electrolyte). In the case where the second electrolyte layer 16 is formed of a non-aqueous electrolyte solution, the aforementioned inorganic fine particles (filler) may be added to the electrolyte solution. Containing inorganic fine particles in the electrolyte solution reduces the internal resistance of the metal-air batteries so as to increase battery capacity and also prevents liquid leakage from the metal-air batteries.

The structures of the above-described metal-air batteries may be applied to metal-air batteries having shapes (e.g., flat plate shape) other than the cylindrical shape. While the above-described embodiments take the example of the secondary batteries, the structures of the above-described metal-air batteries may be applied to primary batteries and fuel cells.

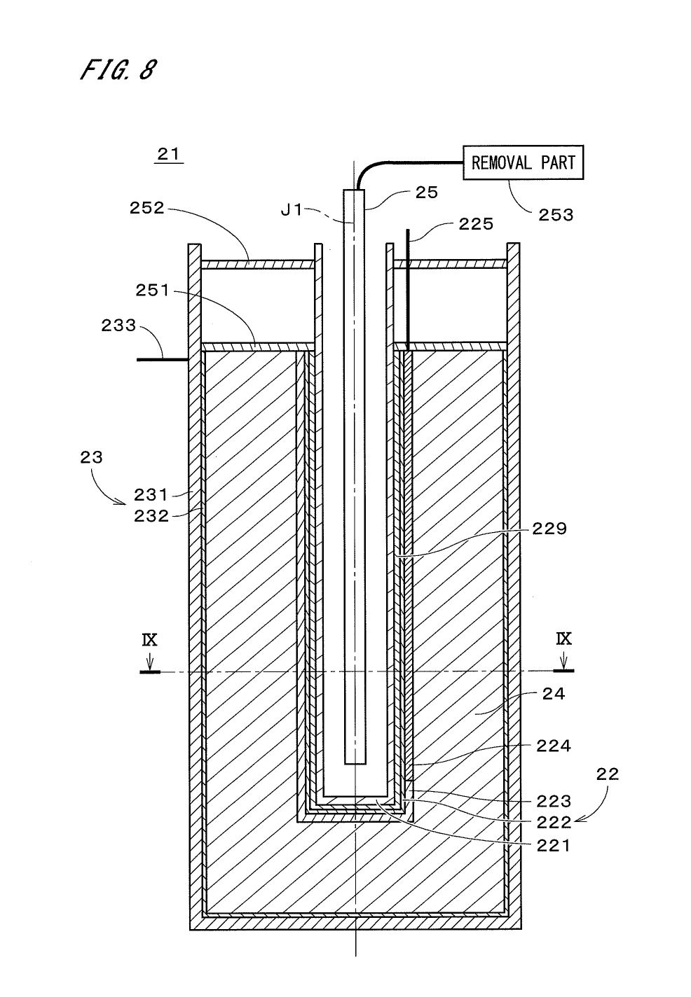

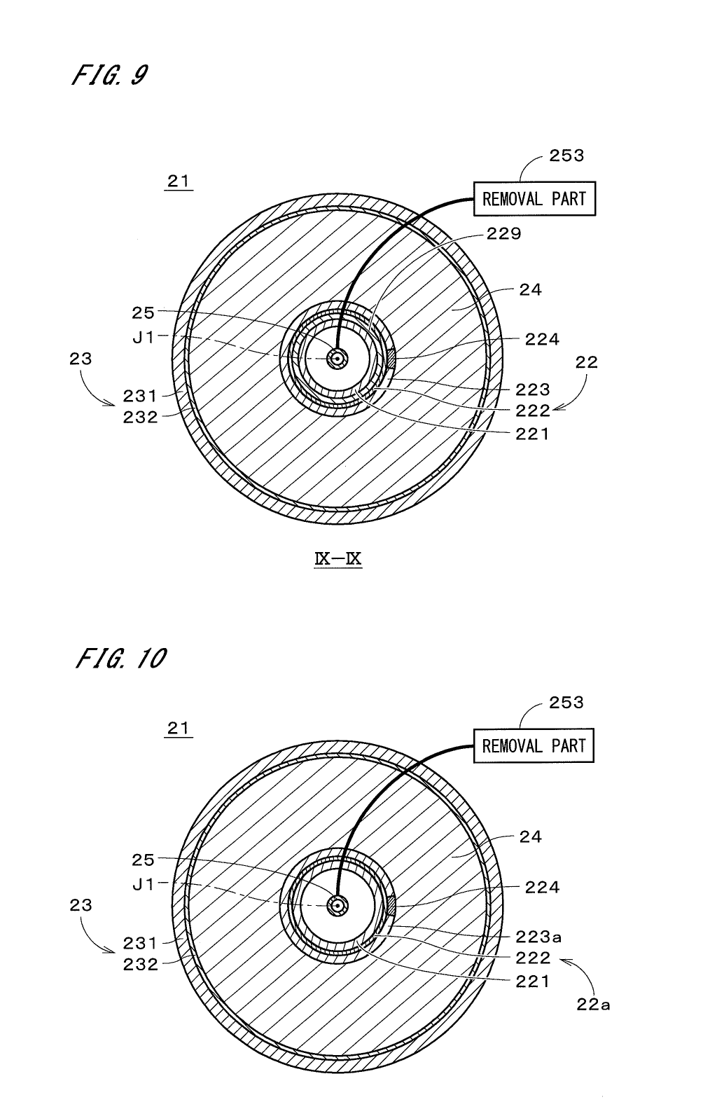

FIG. 8 is a longitudinal cross-sectional view of a metal-air battery 21 according to a sixth embodiment of the present invention. The metal-air battery 21 has a substantially cylindrical shape, and a cross section of the metal-air battery 21 including a central axis J1 thereof is shown in FIG. 8. FIG. 9 is a transverse cross-sectional view of the metal-air battery 21 taken along line IX-IX in FIG. 8. As shown in FIGS. 8 and 9, the metal-air battery 21 is a secondary battery that includes a positive electrode 22, a negative electrode 23, an electrolyte layer 24, and an air introduction pipe 25. The air introduction pipe 25, the positive electrode 22, the electrolyte layer 24, and the negative electrode 23 are concentrically disposed in this order from the central axis J1 toward the outside in the radial direction. In other words, the metal-air battery 21 has a substantially cylindrical shape in which the negative electrode 23 is disposed along its outer periphery and the positive electrode 22 is disposed along its inner periphery.

The positive electrode 22 is a porous member having a substantially cylindrical bottomed shape and includes a positive electrode supporter 221, a positive electrode conductive layer 222, and a positive electrode catalyst layer 223, each of which has a substantially cylindrical bottomed shape. The metal-air battery 21 further includes a porous liquid repellent layer 229 that has liquid repellency to an electrolyte solution, which will be described later (in the present embodiment, liquid repellency to an aqueous electrolyte solution), and the liquid repellent layer 229 is provided in the positive electrode 22. To be more specific, the liquid repellent layer 229 is laminated on the outer side and bottom faces of the positive electrode supporter 221. The positive electrode conductive layer 222 is laminated on the outer side and bottom faces of the liquid repellent layer 229, and the positive electrode catalyst layer 223 is laminated on the outer side and bottom faces of the positive electrode conductive layer 222. The positive electrode 22 is provided with a positive electrode current collector 224 on a part of the outer side face of the positive electrode conductive layer 222 so as to replace the positive electrode catalyst layer 223, and as shown in FIG. 8, a positive electrode current collector terminal 225 is connected to the upper end of the positive electrode current collector 224. The positive electrode 22 and the positive electrode current collector 224 contain no carbon (C).

Like the above-described positive electrode supporter 121, the positive electrode supporter 221 is a porous member formed of ceramics such as alumina (aluminum oxide: Al₂O₃) or zirconia, or metals such as stainless steel, and in the present embodiment, the positive electrode supporter 221 is formed of alumina that is an insulator. The positive electrode supporter 221 is formed using a similar technique to that of the above-described positive electrode supporter 121. The positive electrode conductive layer 222 on the positive electrode supporter 221 is formed in the same manner as the above-described positive electrode conductive layer 122, and the positive electrode catalyst layer 223 is formed in the same manner as the above-described positive electrode catalyst layer 123.

The liquid repellent layer 229 disposed between the positive electrode supporter 221 and the positive electrode conductive layer 222 is formed of a material having liquid repellency, and in the case where the temperature is high during the formation of the positive electrode conductive layer 222, ceramic materials having high heat resistance (e.g., ceramic oxide) are used for the liquid repellent layer 229. In the present embodiment, a porous film formed of silica (silicon dioxide: SiO₂) or a silica composite material is used as the liquid repellent layer 229. Alternatively, the liquid repellent layer 229 may be formed by covering a porous member having no liquid repellency with a substance that includes a functional group such as a saturated fluoroalkyl group (in particular, trifluoromethyl group (CF₃⁻)), an alkylsilyl group, a fluorosilyl group, or a long chain alkyl group.

As shown in FIGS. 8 and 9, the negative electrode 23 includes a negative electrode supporter 231 having a substantially cylindrical bottomed shape and a negative electrode conductive layer 232 having a substantially cylindrical bottomed shape and laminated on the inner side and bottom faces of the negative electrode supporter 231.

The negative electrode supporter 231 is a negative electrode current collector formed of a conductive material such as metals (in the present embodiment, stainless steel), and a negative electrode current collector terminal 233 is provided on the outer side face of the negative electrode supporter 231 as shown in FIG. 8. The negative electrode conductive layer 232 is a thin conductive film formed of metals such as zinc (Zn) or lithium (Li), or an alloy containing these metals. In the present embodiment, the negative electrode conductive layer 232 is formed of zinc or a zinc alloy. The formation of the negative electrode conductive layer 232 is carried out by a slurry coating method, for example.

The electrolyte layer 24 is formed of an aqueous electrolyte, and in the present embodiment, it is formed by charging (disposing) an electrolyte solution that contains potassium hydroxide (KOH) between the positive electrode 22 and the negative electrode 23. The electrolyte layer 24 is in contact with the positive electrode catalyst layer 223 and the positive electrode current collector 224 of the positive electrode 22 and the negative electrode conductive layer 232 of the negative electrode 23. The upper face of the electrolyte layer 24 is closed with a substantially annular inner lid 251 that is in contact with the outer side face of the positive electrode supporter 221 and the inner side face of the negative electrode supporter 231, and a top lid 252 of the same shape as the inner lid 251 is provided above the inner lid 251 so as to close an upper opening of the negative electrode 23 having a substantially cylindrical bottomed shape. Note that the electrolyte solution contained in the electrolyte layer 24 may be other aqueous electrolyte solutions or non-aqueous (e.g., organic solvent) electrolyte solutions.

The air introduction pipe 25 is disposed on the inner side of the positive electrode 22 having a substantially cylindrical bottomed shape, and the lower end of the air introduction pipe 25 is positioned in the vicinity of the bottom of the positive electrode supporter 221 of the positive electrode 22. The upper end of the air introduction pipe 25 is connected to a removal part 253 that removes moisture and carbon dioxide from the air. The removal part 253 removes the moisture and carbon dioxide in the air by membrance separation or by adsorption. The air from the removal part 253 (i.e., the air from which moisture and carbon dioxide have been removed) is led by the air introduction pipe 25 to the vicinity of the bottom on the inner side of the positive electrode 22, then goes up along the inner side face of the positive electrode 22 while being supplied to the positive electrode 22, and is discharged from the upper opening of the positive electrode 22 to the outside. In the metal-air battery 21, the air introduction pipe 25 serves as a gas supply part that supplies the air from the removal part 253 to the positive electrode 22. The air supplied to the positive electrode 22 passes through the positive electrode supporter 221, the liquid repellent layer 229, and the positive electrode conductive layer 222, each of which is a porous member, and is supplied to the positive electrode catalyst layer 223. In the metal-air battery 21, as a general rule, the porous positive electrode catalyst layer 223 provides an interface between the air and the electrolyte solution.

During discharge of the metal-air battery 21 in FIG. 8, the negative electrode current collector terminal 233 and the positive electrode current collector terminal 225 are electrically connected to each other via a load (e.g., lighting equipment). In the negative electrode 23, the metal contained in the negative electrode conductive layer 232 is oxidized into metal ions (here, zinc ions (Zn²⁺)), and electrons are supplied to the positive electrode 22 via the negative electrode current collector terminal 233, the positive electrode current collector terminal 225, and the positive electrode current collector 224. In the positive electrode 22, the oxygen in the air supplied through the air introduction pipe 25 is reduced into oxygen ions (O²⁻) by the electrons supplied from the negative electrode 23. Because the generation of oxygen ions (i.e., reduction reaction of oxygen) in the positive electrode 22 is accelerated by the positive electrode catalyst contained in the positive electrode catalyst layer 223, an overvoltage due to energy consumption during the reduction reaction decreases and thus it is possible to increase the discharge voltage of the metal-air battery 21. The oxygen ions generated in the positive electrode 22 bind to the metal ions dissolved from the negative electrode 23 into the electrolyte layer 24, thereby giving a metal oxide.

During charge of the metal-air battery 21, a voltage is applied between the negative electrode current collector terminal 233 and the positive electrode current collector terminal 225. In the positive electrode 22, the metal oxide is decomposed, and electrons from the oxygen ions are supplied to the positive electrode current collector terminal 225 via the positive electrode current collector 224, generating oxygen. In the negative electrode 23, the metal ions are reduced by the electrons supplied to the negative electrode current collector terminal 233, and the metal is deposited on the surface of the negative electrode conductive layer 232. Because the generation of oxygen in the positive electrode 22 is accelerated by the positive electrode catalyst contained in the positive electrode catalyst layer 223, an overvoltage decreases and thus it is possible to reduce the charge voltage of the metal-air battery 21.

Incidentally, the positive electrodes of ordinary metal-air batteries are primarily formed of carbon for obtaining conductivity, and positive electrode catalysts that accelerate reduction reactions of oxygen are added to the carbon. However, such metal-air batteries will have increased charge voltages because metal ions generated during discharge are deposited as metal carbonate on the positive electrodes, and a large amount of energy is required in order to electrolyze and ionize the metal carbonate during charge.

In contrast, the metal-air battery 21 according to the present embodiment can realize the positive electrode 22 that contains no carbon by forming the positive electrode catalyst layer 223 on the positive electrode conductive layer 222 formed of a perovskite type oxide. As a result, it is possible to prevent the generation of metal carbonate on the positive electrode 22 during discharge and to thereby reduce the charge voltage of the metal-air battery 21. Also, the discharge voltage of the metal-air battery 21 can be increased because the positive electrode conductive layer 222 contains a highly conductive lanthanum perovskite type oxide. Furthermore, by using a perovskite type oxide represented by the chemical formula A₁₋ₓBO₃ (0.9≦1−x<1.0) as the perovskite type oxide contained in the positive electrode conductive layer 222, it is possible to prevent deterioration in the positive electrode conductive layer 222 due to moisture and to thereby improve the durability of the metal-air battery 21.

The metal-air battery 21 can reduce the amount of usage of a relatively expensive perovskite type oxide because the positive electrode conductive layer 222 of the positive electrode 22 is a thin conductive film that is supported (carried) by the positive electrode supporter 221. This results in a reduction in the manufacturing cost of the metal-air battery 21.

Furthermore, in the metal-air battery 21, the liquid repellent layer 229 having liquid repellency to the electrolyte solution contained in the electrolyte layer 24 is provided on the side of the positive electrode conductive layer 222 and the positive electrode catalyst layer 223 opposite to the electrolyte layer 24. Thus, even if the electrolyte solution permeates (passes) through the positive electrode catalyst layer 223 and the positive electrode conductive layer 222, leakage of the electrolyte solution to the inner side of the positive electrode supporter 221 (i.e., in the vicinity of the air introduction pipe 25) can be prevented. Besides, forming the liquid repellent layer 229 of a porous member prevents leakage of the electrolyte solution (liquid leakage) while enabling the supply of air to the positive electrode conductive layer 222 and the positive electrode catalyst layer 223.

As described above, since the metal-air battery 21 has a cylindrical shape in which the negative electrode 23 is disposed along its outer periphery and the positive electrode 22 is disposed along its inner periphery, even if upsizing of the metal-air battery 21 is required, thin film layers such as the negative electrode conductive layer 232 and the positive electrode conductive layer 222 can be readily formed. In other words, it is easy to cope with the upsizing of the metal-air battery 21. Furthermore, because the negative electrode 23, the positive electrode 22, the electrolyte layer 24, and the liquid repellent layer 229 have concentric cylindrical bottomed shapes, it is possible to prevent leakage of the electrolyte solution from both the side and bottom faces of the positive electrode 22. Moreover, the supply of the air from which carbon dioxide has been removed, to the positive electrode 22 through the air introduction pipe 25 prevents the occurrence of a reaction between the carbon dioxide in the air and the metal ions and subsequent adherence of a metal carbonate to the positive electrode 22.

In the metal-air battery 21, inorganic fine particles (filler) may be added to the aqueous electrolyte solution of the electrolyte layer 24. The inorganic fine particles are preferably made of inorganic oxides such as alumina, silicon dioxide (SiO₂), titanium dioxide (TiO₂), zeolite, and perovskite type oxide, and in particular, zeolite particles having a high silicon content (e.g., the ratio of Si to Al is 2 or higher) are more preferable. Containing inorganic fine particles in the electrolyte solution of the electrolyte layer 24 reduces the internal resistance of the metal-air battery 21 and increases the battery capacity and also prevents liquid leakage from the metal-air battery 21. Note that metal-air batteries according to the following seventh to tenth embodiments, which will be described below, can also achieve the same effects as described above (i.e., increase in the battery capacity and prevention of liquid leakage) by containing inorganic fine particles in the electrolyte solutions contained in the electrolyte layers.

FIG. 10 shows another example of the metal-air battery 21 and corresponds to FIG. 9. In a metal-air battery 21 shown in FIG. 10, a positive electrode conductive layer 222 is laminated on the outer side and bottom faces of a positive electrode supporter 221, and a positive electrode catalyst layer 223a is laminated on the outer side and bottom faces of the positive electrode conductive layer 222. That is, the liquid repellent layer 229 in FIG. 9 has been omitted from a positive electrode 22a shown in FIG. 10. The positive electrode catalyst layer 223a has a fractal structure. Specifically, on each of the outer side and bottom faces of the positive electrode conductive layer 222, a catalyst (here, manganese dioxide) is formed in the form of a large number of needles that are substantially perpendicular to the face. This allows the positive electrode catalyst layer 223a to have liquid repellency. The positive electrode catalyst layer 223a is formed by a hydrothermal synthesis method, for example.

In this way, in the metal-air battery 21 in FIG. 10, the (catalyst of the) positive electrode catalyst layer 223a disposed between the positive electrode conductive layer 222 and the electrolyte layer 24 has a fractal structure. This allows the positive electrode catalyst layer 223a to also serve as a liquid repellent layer and block the movement of the electrolyte solution to the inner side (toward the positive electrode conductive layer 222). As a result, it is possible to prevent the electrolyte solution from permeating through the positive electrode 22a and leaking out thereof while simplifying the configuration of the metal-air battery 21. Furthermore, the positive electrode catalyst layer 223a provides a more reliable interface between the electrolyte solution and the air, thus further accelerating oxygen reduction reactions. While a positive electrode current collector 224 is provided on a part of the outer side face of the positive electrode conductive layer 222 (i.e., on a portion where the positive electrode catalyst layer 223a is not formed), the electrolyte solution will not permeate through the positive electrode current collector 224 because the positive electrode current collector 224 is densely formed. In other words, because the positive electrode catalyst layer 223a covers the entire outer side and bottom faces of the positive electrode conductive layer 222 together with an impermeable member, leakage of the electrolyte solution can be prevented. Of course, a configuration is also possible in which the positive electrode catalyst layer 223a is formed on the entire outer side and bottom faces of the positive electrode conductive layer 222, and the positive electrode current collector 224 is provided on the top or the inner side of the positive electrode conductive layer 222.

Alternatively, on the outer side and bottom faces of the positive electrode conductive layer 222, the catalyst of the positive electrode catalyst layer 223a may be formed into a large number of islands or in a porous form. In this case, a liquid repellent material is coated on the catalyst of the positive electrode catalyst layer 223a, and the surface of the liquid repellent material is removed until the catalyst is exposed. Accordingly, the periphery of the catalyst in the form of a large number of islands (of the micrometer-order, for example) or the pore portions of the porous catalyst are filled with the liquid repellent material, which allows the positive electrode catalyst layer 223a to have liquid repellency. Examples of the liquid repellent material that is used include fluorocarbon resins such as Teflon (registered trademark), ceramic materials, and substances that contain a functional group such as a saturated fluoroalkyl group (in particular, a trifluoromethyl group (CF₃⁻)), an alkylsilyl group, a fluorosilyl group, or a long-chain alkyl group.

In this way, if the catalyst of the positive electrode catalyst layer 223a disposed between the positive electrode conductive layer 222 and the electrolyte layer 24 is formed into a large number of islands or in a porous form, a material having liquid repellency to the electrolyte solution is applied to the interstices of the catalyst. This allows the positive electrode catalyst layer 223a to serve also as a liquid repellent layer and block the movement of the electrolyte solution to the inner side. As a result, it is possible to prevent the electrolyte solution from permeating through the positive electrode 22a and leaking out therefrom while simplifying the configuration of the metal-air battery 21. The above-described positive electrode catalyst layer 223a (including the one having a fractal structure) may be applied to the seventh to tenth embodiments, which will be described below.

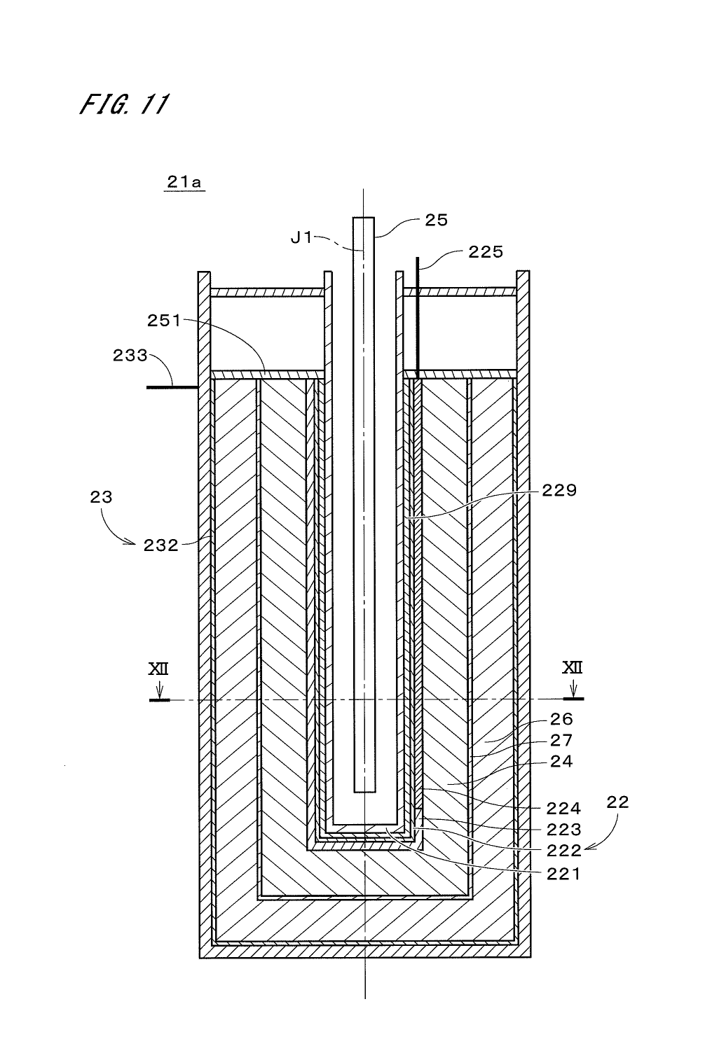

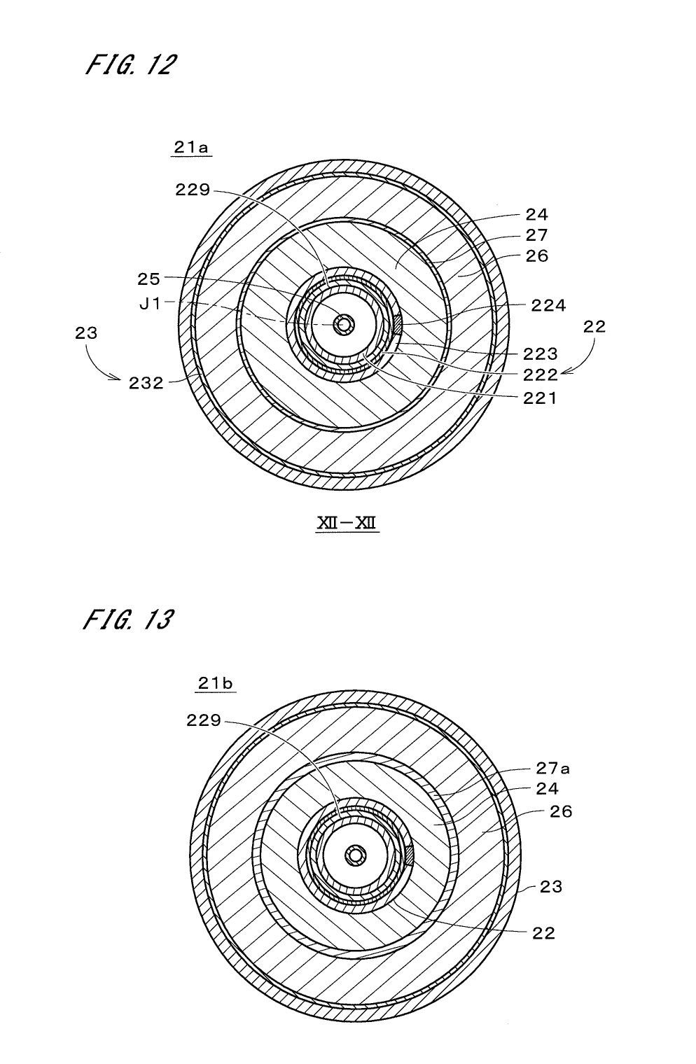

Next is a description of a metal-air battery according to a seventh embodiment of the present invention. FIGS. 11 and 12 are respectively a longitudinal cross-sectional view and a transverse cross-sectional view of a metal-air battery 21a according to the seventh embodiment. FIG. 12 is a cross-sectional view of the metal-air battery 21a taken along line XII-XII in FIG. 11. For the sake of simplicity of the drawings, illustration of a removal part 253 has been omitted from FIGS. 11 and 12 (the same applies to FIGS. 13 to 15).

In the metal-air battery 21a, another electrolyte layer 26 is disposed between an electrolyte layer 24 and a negative electrode 23, and a barrier layer 27 is disposed between the electrolyte layer 24 and the electrolyte layer 26. The barrier layer 27 is a thin-film solid electrolyte and allows only metal ions to selectively pass therethrough. The other constituent elements are the same as those of the metal-air battery 21 shown in FIGS. 8 and 9, and in the following description, corresponding constituent elements are denoted by the same reference numerals. In order to distinguish between the two electrolyte layers 24 and 26, the electrolyte layer 24 and the electrolyte layer 26 are respectively referred to as a “first electrolyte layer 24” and a “second electrolyte layer 26”.

As shown in FIGS. 11 and 12, the second electrolyte layer 26 has a substantially cylindrical bottomed shape with a central axis J1 at the center and is in contact with the negative electrode 23. The barrier layer 27 also has a substantially cylindrical bottomed shape and is in contact with the first electrolyte layer 24 and the second electrolyte layer 26. The second electrolyte layer 26 is formed by charging (disposing) a non-aqueous (e.g., organic solvent) or aqueous electrolyte solution between the negative electrode 23 and the barrier layer 27. Like the upper face of the first electrolyte layer 24, the upper face of the second electrolyte layer 26 is closed with a substantially annular inner lid 251 (shown in only FIG. 11). In the present embodiment, the second electrolyte layer 26 is a porous polymer impregnated with the above electrolyte solution, and the barrier layer 27 that is a thin-film solid electrolyte is supported (carried) on the inner side and bottom faces of the second electrolyte layer 26 by the second electrolyte layer 26. In other words, the second electrolyte layer 26 serves also as a barrier supporting layer that supports the barrier layer 27. As the barrier layer 27, glass ceramics (LTAP) represented by the chemical formula Li_{1+x+y}Ti₂₋ₓAlₓP_{3-y}Si_{y}O₁₂ are used.

During discharge of the metal-air battery 21a, the metal contained in the negative electrode conductive layer 232 of the negative electrode 23 is oxidized into metal ions, and electrons are supplied to the positive electrode 22 via the negative electrode current collector terminal 233, the positive electrode current collector terminal 225, and the positive electrode current collector 224. The negative electrode current collector terminal 233 and the positive electrode current collector terminal 225 are shown in only FIG. 11. In the positive electrode 22, the oxygen in the air supplied through the air introduction pipe 25 is reduced into oxygen ions by the electrons supplied from the negative electrode 23, and the oxygen ions react with the water contained in the first electrolyte layer 24 and turn into hydroxide ions (OH⁻). The hydroxide ions bind to the metal ions that have been dissolved from the negative electrode 23 into the second electrolyte layer 26 and moved to the first electrolyte layer 24, and thereby turn into a metal hydroxide. Since the metal hydroxide is water-soluble, it dissolves in the aqueous electrolyte solution of the first electrolyte layer 24.

During charge of the metal-air battery 21a, a voltage is applied between the negative electrode current collector terminal 233 and the positive electrode current collector terminal 225. In the positive electrode 22, electrons from the hydroxide ions are supplied to the positive electrode current collector terminal 225, generating water and oxygen. In the negative electrode 23, metal ions are reduced by the electrons supplied to the negative electrode current collector terminal 233, and the metal is deposited on the surface of the negative electrode conductive layer 232.

Since the positive electrode 22 of the metal-air battery 21a contains no carbon as in the sixth embodiment, it is possible to prevent the generation of a metal carbonate on the positive electrode 22 during discharge and to thereby reduce the charge voltage of the metal-air battery 21a. In particular, providing the barrier layer 27 between the positive electrode 22 and the negative electrode 23 in the metal-air battery 21a suppresses, when the metal is deposited in dendritic form on the negative electrode 23 during charge, the growth of deposited dendritic portions (so-called dendrites) toward the positive electrode 22. As a result, it is possible to prevent dendrites from reaching the positive electrode 22 and causing a short circuit. Furthermore, supporting the barrier layer 27 by the second electrolyte layer 26 facilitates installation of the thin-film barrier layer 27, resulting in downsizing of the metal-air battery 21a. Moreover, since the barrier layer 27 is in the form of a thin film, ionic conductivity is increased more than when the barrier layer 27 is formed thick.

In the metal-air battery 21a, the porous liquid repellent layer 229 having liquid repellency to the electrolyte solution of the first electrolyte layer 24 is provided between the positive electrode supporter 221 and the positive electrode conductive layer 222 of the positive electrode 22 that is in contact with the first electrolyte layer 24. Thus, it is possible to prevent leakage of the electrolyte solution contained in the first electrolyte layer 24 while enabling the supply of air to the positive electrode conductive layer 222 and the positive electrode catalyst layer 223.

Next is a description of a metal-air battery according to an eighth embodiment of the present invention. FIG. 13 is a transverse cross-sectional view of a metal-air battery 21b according to the eighth embodiment. In the metal-air battery 21b, a barrier layer 27a that serves as a separator is provided instead of the barrier layer 27 (solid electrolyte) of the metal-air battery 21a shown in FIGS. 11 and 12. The other constituent elements are the same as those of the metal-air battery 21a shown in FIGS. 11 and 12, and in the following description, corresponding constituent elements are denoted by the same reference numerals.

The barrier layer 27a is a porous member formed of ceramics, metals, inorganic materials, organic materials, or the like and holds an electrolyte in its pores, the electrolyte allowing metal ions to selectively pass therethrough. The formation of the barrier layer 27a is carried out by extrusion molding, CIP and firing, HIP, or the like. Reactions during the charge and discharge of the metal-air battery 21b are the same as those of the metal-air battery 21a according to the seventh embodiment.

Since the positive electrode 22 of the metal-air battery 21b contains no carbon as in the sixth and seventh embodiments, it is possible to prevent the generation of a metal carbonate on the positive electrode 22 during discharge and to thereby reduce the charge voltage of the metal-air battery 21b. Furthermore, providing the barrier layer 27a between the positive electrode 22 and the negative electrode 23 makes it possible to suppress the growth of dendrites on the negative electrode 23 during charge, thus preventing the occurrence of a short circuit as in the seventh embodiment. Moreover, since the positive electrode 22 is provided with the liquid repellent layer 229 that has liquid repellency to the electrolyte solution of the first electrolyte layer 24, leakage of the electrolyte solution can be prevented. In particular, since the installation of the barrier layer 27a serving as a separator does not require the support of the second electrolyte layer 26, the metal-air battery 21b can have a higher degree of freedom in selecting the material for the second electrolyte layer 26.

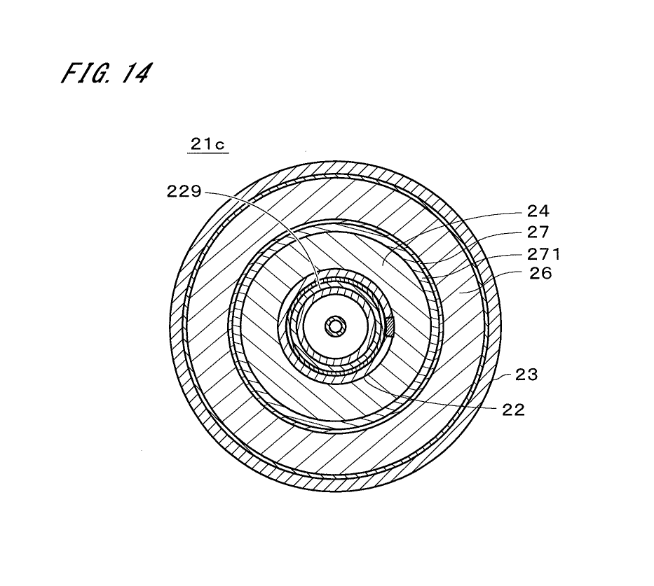

Next is a description of a metal-air battery according to a ninth embodiment of the present invention. FIG. 14 is a transverse cross-sectional view of a metal-air battery 21c according to the ninth embodiment. The metal-air battery 21c has the same configuration as the metal-air battery 21a shown in FIGS. 11 and 12, with the exception that a barrier supporting layer 271 is provided between a first electrolyte layer 24 and a barrier layer 27. In the following description, corresponding constituent elements are denoted by the same reference numerals.

The barrier supporting layer 271 is a porous member formed of ceramics, metals, inorganic materials, organic material, or the like by a method such as extrusion molding, CIP and firing, or HIP, and pores of the barrier supporting layer 271 are impregnated with an aqueous electrolyte solution of the first electrolyte layer 24. The barrier layer 27 that is a thin-film solid electrolyte is supported (carried) on the outer side and bottom faces of the barrier supporting layer 271 by the barrier supporting layer 271. Reactions during the charge and discharge of the metal-air battery 21c are the same as those of the metal-air battery 21a according to the seventh embodiment.

Since the positive electrode 22 of the metal-air battery 21c contains no carbon as in the sixth to eighth embodiments, it is possible to prevent the generation of a metal carbonate on the positive electrode 22 during discharge and to thereby reduce the charge voltage of the metal-air battery 21c. Furthermore, providing the barrier layer 27 and the barrier supporting layer 271 between the positive electrode 22 and the negative electrode 23 makes it possible to suppress the growth of dendrites on the negative electrode 23 during charge, thus preventing the occurrence of a short circuit as in the seventh embodiment. Moreover, since the positive electrode 22 is provided with the liquid repellent layer 229 that has liquid repellency to the electrolyte solution of the first electrolyte layer 24, leakage of the electrolyte solution can be prevented. As described above, since the barrier layer 27 is supported by the barrier supporting layer 271 and does not require the support of the second electrolyte layer 26, the metal-air battery 21c can have a higher degree of freedom in selecting the material for the second electrolyte layer 26.

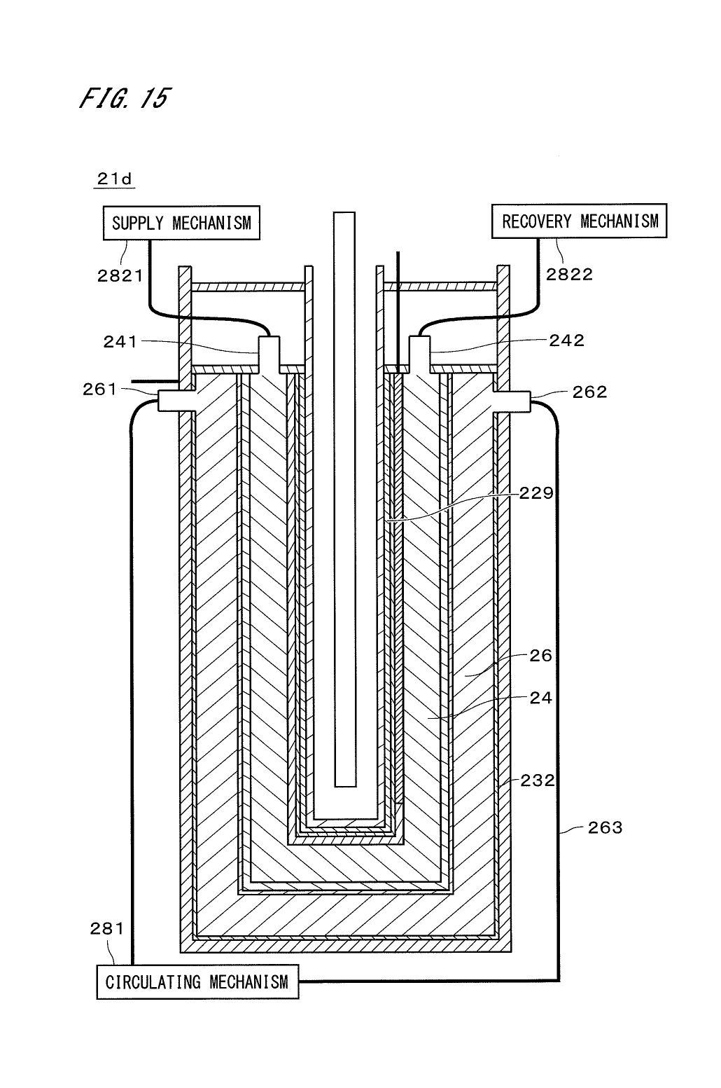

Next is a description of a metal-air battery according to a tenth embodiment of the present invention. FIG. 15 is a longitudinal cross-sectional view of a metal-air battery 21d according to the tenth embodiment. The metal-air battery 21d has the same configuration as the metal-air battery 21c shown in FIG. 14, with the exception that a second electrolyte layer 26 is connected to a circulating mechanism 281 for circulating a non-aqueous or aqueous electrolyte solution of the second electrolyte layer 26 and that a first electrolyte layer 24 is connected to an exchange mechanism for exchanging an aqueous electrolyte solution of the first electrolyte layer 24. In the following description, corresponding constituent elements are denoted by the same reference numerals.

As shown in FIG. 15, a supply port 261 from which an electrolyte solution is supplied to the second electrolyte layer 26 and a discharge port 262 from which the electrolyte solution of the second electrolyte layer 26 is discharged are formed on the side portion of the metal-air battery 21d. The supply port 261 and the discharge port 262 are connected to the circulating mechanism 281 via a pipeline 263, and the electrolyte solution discharged from the discharge port 262 is supplied again from the supply port 261 to the second electrolyte layer 26 via the circulating mechanism 281. This produces the flow of the electrolyte solution inside the second electrolyte layer 26, thus suppressing the generation and growth of dendrites during the charge of the metal-air battery 21d. The circulating mechanism 281 is also provided with a filter, and if thin pieces of metal fall off from the negative electrode conductive layer 232 during charge or the like, these pieces of metal will be recovered by the circulating mechanism 281.

The metal-air battery 21d is also provided with a supply port 241 from which an electrolyte solution is supplied to the first electrolyte layer 24 and a discharge port 242 from which the electrolyte solution of the first electrolyte layer 24 is discharged. The supply port 241 is connected to a supply mechanism 2821 of the aforementioned exchange mechanism, and a new electrolyte solution is supplied from the supply mechanism 2821 to the first electrolyte layer 24. The discharge port 242 is connected to a recovery mechanism 2822 of the exchange mechanism, and the electrolyte solution discharged from the first electrolyte layer 24 is recovered by the recovery mechanism 2822. This prevents the electrolyte solution of the first electrolyte layer 24 from being saturated with a metal hydroxide during the discharge of the metal-air battery 21d, thus increasing the discharge duration of the metal-air battery 21d. A metal (metal forming the negative electrode conductive layer 232) is recovered from the electrolyte solution recovered by the recovery mechanism 2822. This metal may be reused as the negative electrode conductive layer 232 of the metal-air battery.

While the above has been a description of the sixth to tenth embodiments of the present invention, the above-described embodiments can be modified in various ways.

While in the metal-air batteries 21 and 21a to 21d shown in FIGS. 8, 11, and 13 to 15, the liquid repellent layer 229 is provided between the positive electrode conductive layer 222 and the positive electrode supporter 221, the liquid repellent layer 229 may be provided on the inner side of the positive electrode supporter 221 (on the central axis J1 side) depending on the design of the metal-air batteries 21.

In the negative electrode 23, the negative electrode supporter 231 does not necessarily have to be formed of a conductive material, and in the case where the negative electrode supporter 231 is formed of an insulator, the negative electrode current collector terminal 233 penetrates through the negative electrode supporter 231 and is electrically connected to the negative electrode conductive layer 232. Also, the negative electrode supporter 231 does not necessarily have to be provided, and the entire negative electrode 23 may be made of zinc or a zinc alloy. The negative electrode conductive layer 232 may be formed of various materials including metals that are oxidized into metal ions during discharge.

In the positive electrode 22, in the case where the positive electrode supporter 221 is formed of a conductive material, the positive electrode current collector 224 may be omitted and the positive electrode current collector terminal 225 may be provided on the inner side face of the positive electrode supporter 221. In the case where the positive electrode conductive layer 222 has a certain degree of thickness, the positive electrode supporter 221 that supports the positive electrode conductive layer 222 may be omitted. In this case, the positive electrode current collector terminal 225 is provided on the inner side face of the positive electrode conductive layer 222.

In the metal-air batteries, the positive electrode 22 may be configured by forming a conductive layer from a mixture of the material for the positive electrode supporter 221 and the material for the positive electrode conductive layer 222 (i.e., perovskite type oxide) and forming the positive electrode catalyst layer 223 on that conductive layer.

Alternatively, the positive electrode 22 may be formed from a mixture of the material for the positive electrode supporter 221, the material for the positive electrode conductive layer 222, and the material for the positive electrode catalyst layer 223. In either case, the positive electrode 22 contains a perovskite type oxide having electrical conductivity and a catalyst that accelerates oxygen reduction reactions, but no carbon. Thus, it is possible to prevent the generation of a carbonate salt of the metal contained in the negative electrode 23 on the positive electrode 22 during the discharge of the metal-air batteries.

While the above embodiments describe the case in which the electrolyte layer 24 that is in contact with the positive electrode 22 uses an aqueous electrolyte solution and the liquid repellent layer 229 (or the positive electrode catalyst layer 223a also serving as a liquid repellent layer in the positive electrode 22a shown in FIG. 10) has liquid repellency, even in the case of using a non-aqueous electrolyte solution, permeation and leakage of the electrolyte solution into and out of the positive electrode can be prevented by providing the positive electrode with a liquid repellent layer that has liquid repellency to the electrolyte solution.

The structures of the above-described metal-air batteries may be applied to metal-air batteries having shapes (e.g., flat plate shape) other than the cylindrical shape. While the above-described embodiments take the example of the secondary batteries, the structures of the above-described metal-air batteries may be applied to primary batteries or fuel cells.

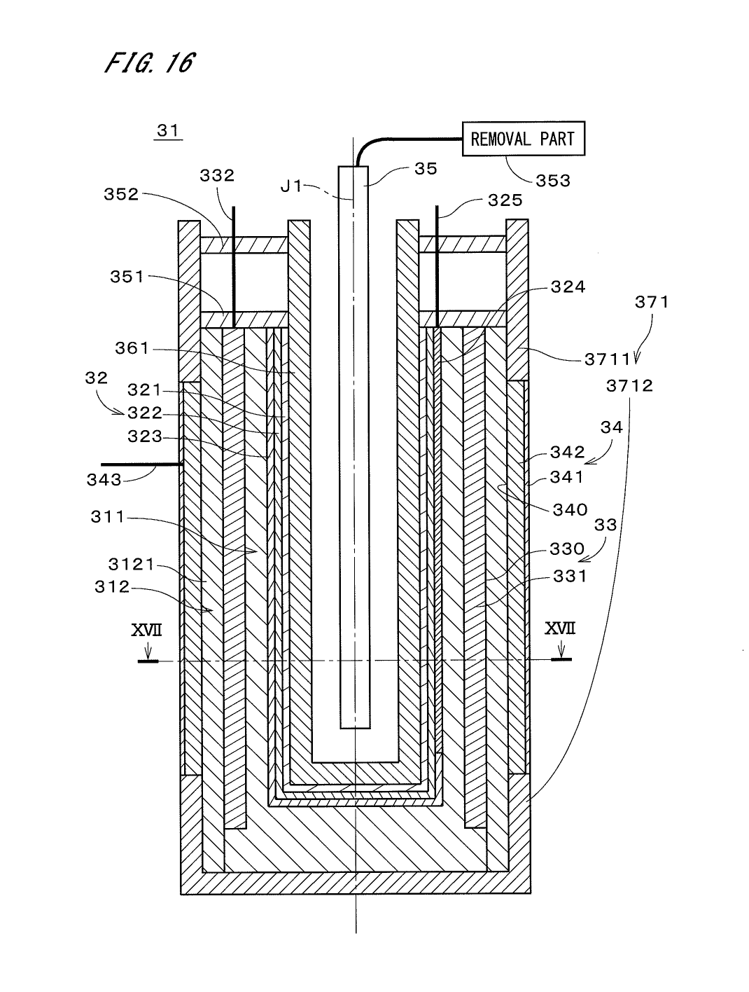

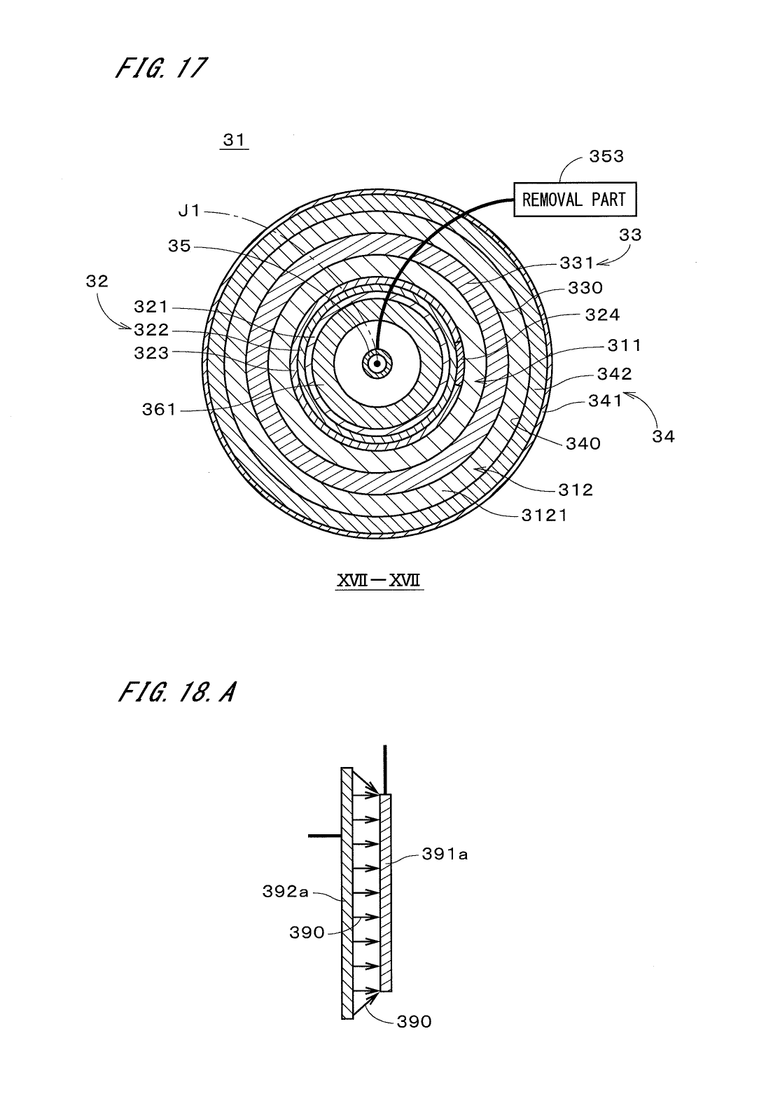

FIG. 16 is a longitudinal cross-sectional view of a metal-air battery 31 according to an eleventh embodiment of the present invention. The metal-air battery 31 has a substantially cylindrical shape, and a cross section of the metal-air battery 31 including a central axis J1 thereof is shown in FIG. 16. FIG. 17 is a transverse cross-sectional view of the metal-air battery 31 taken along line XVII-XVII in FIG. 16. As shown in FIGS. 16 and 17, the metal-air battery 31 is a secondary battery that includes a positive electrode layer 32, a negative electrode layer 33, and an electrolyte layer 311. The metal-air battery 31 further includes an air introduction pipe 35, another electrolyte layer 312, and an auxiliary electrode layer 34. The air introduction pipe 35, the positive electrode layer 32, the electrolyte layer 311, the negative electrode layer 33, the electrolyte layer 312, and the auxiliary electrode layer 34 are concentrically disposed in this order from the central axis J1 toward the outside in the radial direction. In the following description, the electrolyte layer 311 disposed between the positive electrode layer 32 and the negative electrode layer 33 is referred to as the “first electrolyte layer 311”, and the electrolyte layer 312 disposed between the negative electrode layer 33 and the auxiliary electrode layer 34 is referred to as the “second electrolyte layer 312”.

The positive electrode layer 32 is a porous member having a substantially cylindrical bottomed shape and includes a positive electrode conductive layer 322 and a positive electrode catalyst layer 323, each of which has a substantially cylindrical bottomed shape, and a porous liquid repellent layer 321 having liquid repellency to an electrolyte solution, which will be described later (in the present embodiment, liquid repellency to an aqueous electrolyte solution). Specifically, in the metal-air battery 31, a positive electrode supporter 361 having a substantially cylindrical bottomed shape with the central axis J1 at the center is provided, and the liquid repellent layer 321 is laminated on the outer side and bottom faces of the positive electrode supporter 361. The positive electrode conductive layer 322 is laminated on the outer side and bottom faces of the liquid repellent layer 321, and the positive electrode catalyst layer 323 is laminated on the outer side and bottom faces of the positive electrode conductive layer 322. The positive electrode layer 32 is provided with a positive electrode current collector 324 on a part of the outer side face of the positive electrode conductive layer 322 so as to replace the positive electrode catalyst layer 323, and as shown in FIG. 16, a positive electrode current collector terminal 325 is connected to the upper end of the positive electrode current collector 324. Preferably, the positive electrode layer 32 (namely, the liquid repellent layer 321, the positive electrode conductive layer 322, the positive electrode catalyst layer 323, and the positive electrode current collector 324) contains no carbon (C).

The positive electrode supporter 361 is formed in the same manner as the above-described positive electrode supporters 121 and 221, and the positive electrode conductive layer 322 is formed in the same manner as the above-described positive electrode conductive layers 122 and 222. The positive electrode catalyst layer 323 is formed in the same manner as the above-described positive electrode catalyst layers 123 and 223, and the liquid repellent layer 321 disposed between the positive electrode supporter 361 and the positive electrode conductive layer 322 is formed in the same manner as the above-described liquid repellent layer 229.

As shown in FIGS. 16 and 17, the negative electrode layer 33 includes a cylindrical negative electrode conductive layer 331 disposed on the outer side of the cylindrical positive electrode layer 32, and a negative electrode current collector terminal 332 is provided on the upper end of the negative electrode conductive layer 331 as shown in FIG. 16. The negative electrode conductive layer 331 is a porous member formed of metals such as zinc (Zn) or lithium (Li) or an alloy containing these metals. In the present embodiment, the negative electrode conductive layer 331 is formed of zinc or a zinc alloy.

The auxiliary electrode layer 34 serving as a third electrode for charging includes a cylindrical auxiliary conductive layer 342 disposed on the outer side of the cylindrical negative electrode layer 33. The auxiliary conductive layer 342 is a porous member formed of a conductive material such as metals (in the present embodiment, stainless steel). The metal-air battery 31 is also provided with an auxiliary electrode supporter 371 formed of an insulating material as shown in FIG. 16. The auxiliary electrode supporter 371 includes an upper supporter 3711 having a cylindrical shape and a lower supporter 3712 having a cylindrical bottomed shape. The auxiliary conductive layer 342, the upper supporter 3711, and the lower supporter 3712 have the same diameter. The upper end of the auxiliary conductive layer 342 is fixed to the upper supporter 3711, and the lower end thereof is fixed to the lower supporter 3712. In the metal-air battery 31, the auxiliary conductive layer 342 and the auxiliary electrode supporter 371 form a cylindrical bottomed container in which the positive electrode layer 32, the negative electrode layer 33, the first electrolyte layer 311, and the second electrolyte layer 312 are housed. Note that the vertical direction (direction along the central axis J1) in FIG. 16 is not limited to the direction of gravity.

The auxiliary conductive layer 342 is disposed such that its inner side face 340 is equidistantly spaced from an outer side face 330 of the negative electrode conductive layer 331 on the opposite side to the positive electrode layer 32. In other words, the distance (shortest distance) from each position on the inner side face 340 of the auxiliary conductive layer 342 to the outer side face 330 of the negative electrode conductive layer 331 is substantially the same throughout the entire inner side face 340. Furthermore, an auxiliary electrode current collector terminal 343 is connected to the outer side face of the auxiliary conductive layer 342, and a liquid repellent layer 341 similar to the liquid repellent layer 321 is formed over the entire outer side face of the auxiliary conductive layer 342.

The first electrolyte layer 311 is formed of an aqueous electrolyte, and in the present embodiment, an electrolyte solution containing potassium hydroxide (KOH) (e.g., an 8M-KOH aqueous solution in which an 8-mol KOH is dissolved per liter of water) is charged (disposed) between the positive electrode layer 32 and the negative electrode layer 33 to form the first electrolyte layer 311. The first electrolyte layer 311 is in contact with the positive electrode catalyst layer 323 and the positive electrode current collector 324 of the positive electrode layer 32 and the negative electrode conductive layer 331 of the negative electrode layer 33. As shown in FIG. 16, the upper face of the first electrolyte layer 311 is closed with a substantially annular inner lid 351 that is in contact with the outer side face of the positive electrode supporter 361 and the inner side face of the auxiliary electrode supporter 371, and a top lid 352 of the same shape as the inner lid 351 is provided above the inner lid 351 so as to close an opening above the inner lid 351. Note that the electrolyte solution contained in the first electrolyte layer 311 may be other aqueous electrolyte solutions or non-aqueous (e.g., organic solvent) electrolyte solutions.

The second electrolyte layer 312 disposed between the negative electrode layer 33 and the auxiliary electrode layer 34 includes a porous member 3121 formed of ceramics, inorganic materials, organic materials, or the like, and the porous member 3121 is molded by a method such as extrusion molding, CIP and firing, or HIP. As shown in FIG. 16, the second electrolyte layer 312 and the first electrolyte layer 311 communicate with each other via a gap between the lower end of the negative electrode conductive layer 331 and the lower supporter 3712, and pores of the porous member 3121 are impregnated with the aqueous electrolyte solution of the first electrolyte layer 311. That is, the second electrolyte layer 312 is also filled with the electrolyte solution.

The air introduction pipe 35 is disposed on the inner side of the positive electrode supporter 361 having a substantially cylindrical bottomed shape, and the lower end of the air introduction pipe 35 is positioned in the vicinity of the bottom of the positive electrode supporter 361. The upper end of the air introduction pipe 35 is connected to a removal part 353 that removes moisture and carbon from the air. The removal part 353 removes the moisture and carbon dioxide in the air by membrance separation or by adsorption. The air from the removal part 353 (i.e., air from which moisture and carbon dioxide have been removed) is led by the air introduction pipe 35 to the vicinity of the bottom on the inner side of the positive electrode supporter 361, then goes up along the inner side face of the positive electrode supporter 361 while being supplied to the positive electrode layer 32 via the side portion of the positive electrode supporter 361, which is a porous member, and is discharged from the upper opening of the positive electrode supporter 361 to the outside. In the metal-air battery 31, the air introduction pipe 35 serves as a gas supply part that supplies the air from the removal part 353 to the positive electrode layer 32. The air supplied to the positive electrode layer 32 passes through the liquid repellent layer 321 and the positive electrode conductive layer 322, which are porous members, and is supplied to the positive electrode catalyst layer 323. In the metal-air battery 31, as a general rule, the porous positive electrode catalyst layer 323 provides an interface between the air and the electrolyte solution.

In the metal-air battery 31 shown in FIGS. 16 and 17, for example, the outer side face of the positive electrode layer 32 has a diameter of 16 millimeters (mm), the inner side face of the negative electrode layer 33 has a diameter of 20 mm, the outer side face 330 of the negative electrode layer 33 has a diameter of 24 mm, and the inner side face 340 of the auxiliary electrode layer 34 has a diameter of 28 mm. Note that the spacing between the positive electrode layer 32 and the negative electrode layer 33 (thickness of the first electrolyte layer 311) and the spacing between the negative electrode layer 33 and the auxiliary electrode layer 34 (thickness of the second electrolyte layer 312) are preferably 4 mm or less (and 1 mm or more).

During discharge of the metal-air battery 31 in FIG. 16, the negative electrode current collector terminal 332 and the positive electrode current collector terminal 325 are electrically connected to each other via a load (e.g., lighting equipment). In the negative electrode layer 33, the metal contained in the negative electrode conductive layer 331 is oxidized into metal ions (here, zinc ions (Zn²⁺)), and electrons are supplied to the positive electrode layer 32 via the negative electrode current collector terminal 332, the positive electrode current collector terminal 325, and the positive electrode current collector 324. In the positive electrode layer 32, the oxygen in the air supplied through the air introduction pipe 35 is reduced into oxygen ions (O²⁻) by the electrons supplied from the negative electrode layer 33. Because the generation of oxygen ions (i.e., reduction reaction of oxygen) in the positive electrode layer 32 is accelerated by the positive electrode catalyst contained in the positive electrode catalyst layer 323, an overvoltage due to energy consumption during the reduction reaction decreases and thus it is possible to increase the discharge voltage of the metal-air battery 31. The oxygen ions generated in the positive electrode layer 32 bind to the metal ions dissolved from the negative electrode layer 33 into the first electrolyte layer 311, and thereby turn into metal oxide.

During charge of the metal-air battery 31, a voltage is applied between the negative electrode current collector terminal 332 and the auxiliary electrode current collector terminal 343, i.e., between the negative electrode layer 33 and the auxiliary electrode layer 34. In the auxiliary electrode layer 34, the metal oxide is decomposed, and electrons from oxygen ions are supplied to the auxiliary electrode current collector terminal 343, generating oxygen. In the negative electrode layer 33, metal ions are reduced by the electrons supplied to the negative electrode current collector terminal 332, and the metal is deposited on the surface (outer side face 330) of the negative electrode conductive layer 331. The current density between the auxiliary electrode layer 34 and the negative electrode layer 33 during charge is 70 [mA/cm²], for example. In actuality, there is a small gap between the porous member 3121 of the second electrolyte layer 312 and the negative electrode layer 33, and in that gap, the metal is substantially uniformly deposited on the substantially entire outer side face 330 of the negative electrode conductive layer 331 for later-described reasons. Note that the oxygen generated in the auxiliary electrode layer 34 is discharged through the porous auxiliary conductive layer 342 and the liquid repellent layer 341 to the outside.

Incidentally, the positive electrode layers of ordinary metal-air batteries are made primarily of carbon for obtaining conductivity, and positive electrode catalysts that accelerate reduction reactions of oxygen are added to the carbon. However, such metal-air batteries will become deteriorated because metal ions generated during discharge are deposited as a metal carbonate on the positive electrodes.

In contrast, the metal-air battery 31 according to the present embodiment can realize the positive electrode layer 32 that contains no carbon, by forming the positive electrode catalyst layer 323 on the positive electrode conductive layer 322 formed of a perovskite type oxide. As a result, it is possible to prevent the generation of a metal carbonate on the positive electrode layer 32 during discharge. Also, the discharge voltage of the metal-air battery 31 can be increased because the positive electrode conductive layer 322 contains a highly conductive lanthanum perovskite type oxide. Furthermore, by using a perovskite type oxide represented by the chemical formula A₁₋ₓBO₃ (0.9≦1−x<1.0) as the perovskite type oxide contained in the positive electrode conductive layer 322, it is possible to prevent deterioration in the positive electrode conductive layer 322 due to moisture and to thereby improve the durability of the metal-air battery 31.

The metal-air battery 31 can reduce the amount of usage of a relatively expensive perovskite type oxide because the positive electrode conductive layer 322 of the positive electrode layer 32 is a thin conductive film that is supported (carried) by the positive electrode supporter 361. This results in a reduction in the manufacturing cost of the metal-air battery 31. Furthermore, the supply of the air from which carbon dioxide has been removed to the positive electrode layer 32 through the air introduction pipe 35 prevents the occurrence of a reaction between the carbon dioxide in the air and the metal ions and subsequent adherence of a metal carbonate to the positive electrode layer 32.

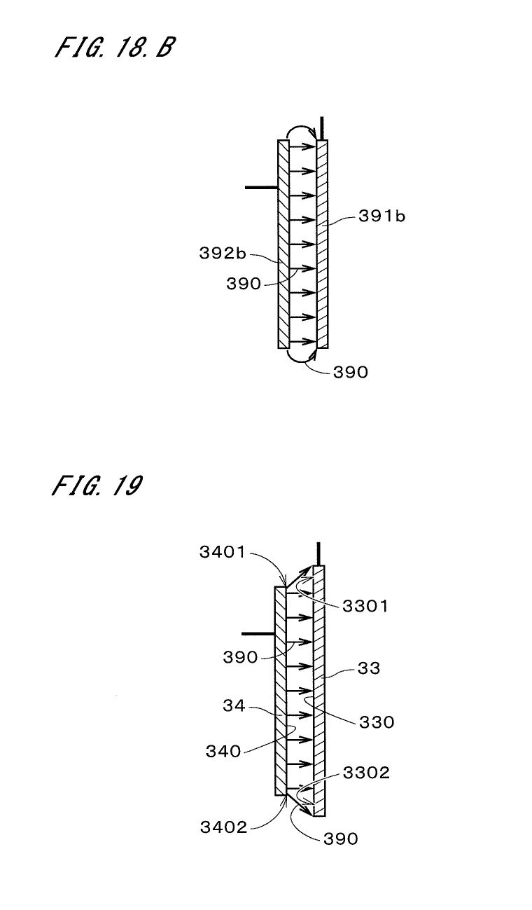

Next, the relationship between the negative electrode layer and the auxiliary electrode layer in the metal-air battery will be described. FIGS. 18.A and 18.B show negative electrode layers and auxiliary electrode layers in metal-air batteries according to comparative examples, the negative electrode layers and the auxiliary electrode layers corresponding respectively to the negative electrode layer 33 and the auxiliary electrode layer 34 on the left side of the central axis J1 in FIG. 16. In FIGS. 18.A and 18.B, only negative electrode layers 391a and 391b and auxiliary electrode layers 392a and 392b are shown, and the directions of electric fields during charge are indicated by arrows denoted by reference numeral 390.

As shown in FIG. 18.A, in the case where the vertical length of the auxiliary electrode layer 392a is longer than that of the negative electrode layer 391a, the current density between the auxiliary electrode layer 392a and the negative electrode layer 391a increases at upper and lower end portions of the negative electrode layer 391a, causing current concentration at these end portions. In this case, the metal in the electrolyte solution will be non-uniformly deposited on the upper and lower end portions of the negative electrode layer 391a, which may result in a short circuit between the auxiliary electrode layer 392a and the negative electrode layer 391a. Even in the case where the vertical length of the auxiliary electrode layer 392b is equal to that of the negative electrode layer 391b as shown in FIG. 18.B, current concentration and non-uniform metal deposition will occur in upper and lower end portions of the negative electrode layer 391b.

In contrast, in the metal-air battery 31 as shown in FIG. 19, the vertical length of the (auxiliary conductive layer 342 of the) auxiliary electrode layer 34 is shorter than that of the (negative electrode conductive layer 331 of the) negative electrode layer 33, and in the case of the cylindrical metal-air battery 31 shown in FIG. 16, the area of the outer side face 330 of the negative electrode layer 33 disposed on the inner side is greater than that of the inner side face 340 of the auxiliary electrode layer 34 disposed on the outer side. If the inner side face 340 of the auxiliary electrode layer 34 and the outer side face 330 of the negative electrode layer 33 are respectively referred to as an “auxiliary opposed face 340” and a “negative electrode opposed face 330”, the negative electrode opposed face 330 has portions 3301 and 3302 that extend outwardly from portions facing the edges of the auxiliary opposed face 340 (in FIG. 19, an upper end portion 3401 and a lower end portion 3402 of the auxiliary opposed face 340). Accordingly, it is possible to prevent the current density between the negative electrode layer 33 and the auxiliary electrode layer 34 from increasing at the upper and lower end portions of the negative electrode layer 33 during charge. Consequently, the metal can be substantially uniformly deposited on the negative electrode opposed face 330 of the negative electrode layer 33 (local metal deposition is prevented), and the occurrence of a short circuit between the negative electrode layer 33 and the auxiliary electrode layer 34 can be prevented.

Furthermore, forming the negative electrode layer 33 of a porous member facilitates metal deposition in active pore portions and enables suppression of dendritic deposition of metals (occurrence of so-called “dendrites”) on the negative electrode layer 33. Moreover, forming the auxiliary electrode layer 34 of stainless steel suppresses the generation of carbon dioxide during charge using an electrode formed of carbon.

In the metal-air battery 31, the liquid repellent layer 321 having liquid repellency to the electrolyte solution contained in the first electrolyte layer 311 is provided on the side of the positive electrode conductive layer 322 and the positive electrode catalyst layer 323 opposite to the first electrolyte layer 311. Thus, even if the electrolyte solution permeates (passes) through the positive electrode catalyst layer 323 and the positive electrode conductive layer 322, it is possible to prevent leakage of the electrolyte solution to the inner side of the positive electrode supporter 361 (i.e., to the vicinity of the air introduction pipe 35). Furthermore, the liquid repellent layer 321 formed of a porous member can prevent leakage of the electrolyte solution (liquid leakage) while enabling the supply of air to the positive electrode conductive layer 322 and the positive electrode catalyst layer 323.

In the auxiliary electrode layer 34, the liquid repellent layer 341 formed of a porous member and having liquid repellency to an electrolyte solution is provided on the side of the auxiliary conductive layer 342 opposite to the second electrolyte layer 312. Thus, it is possible to prevent leakage of the electrolyte solution to the outside of the auxiliary electrode layer 34 while enabling the supply of air to the auxiliary conductive layer 342.

Depending on the design of the metal-air battery 31, inorganic fine particles (filler) may be added to the aqueous electrolyte solution of the first and second electrolyte layers 311 and 312. The inorganic fine particles are preferably made of inorganic oxides such as alumina, silicon dioxide (SiO₂), titanium dioxide (TiO₂), zeolite, and perovskite type oxides, and in particular, zeolite particles having a high silicon content (e.g., the ratio of Si to Al is 2 or higher) are more preferable. Containing inorganic fine particles in the electrolyte solution of the first electrolyte layer 311 reduces the internal resistance of the metal-air battery 31 and increases the battery capacity, and also prevents liquid leakage from the metal-air battery 31.

While the above has been a description of the eleventh embodiment of the present invention, the above-described embodiment can be modified in various ways.

Solid electrolytes may be used for the first and second electrolyte layers 311 and 312. The liquid repellent layer may be provided as necessary, and in the case of using a solid electrolyte, for example, the liquid repellent layer may be omitted. The negative electrode conductive layer 331 of the negative electrode layer 33 may be formed of various materials including metals that are oxidized and generate (release) metal ions during discharge.

In the positive electrode layer 32, in the case where the positive electrode supporter 361 and the liquid repellent layer 321 are formed of conductive materials, the positive electrode current collector 324 may be omitted, and the positive electrode current collector terminal 325 may be provided on the inner side face of the positive electrode supporter 361. In the case where the positive electrode conductive layer 322 has a certain degree of thickness, the positive electrode supporter 361 that supports the positive electrode conductive layer 322 may be omitted. In this case, the positive electrode current collector terminal 325 is provided on the inner side face of the positive electrode conductive layer 322.

In the metal-air battery, the positive electrode layer 32 may be configured by forming a conductive layer from a mixture of the material for the positive electrode supporter 361 and the material for the positive electrode conductive layer 322 (i.e., perovskite type oxide) and forming the positive electrode catalyst layer 323 on that conductive layer. Alternatively, the positive electrode layer 32 may be formed from a mixture of the material for the positive electrode supporter 361, the material for the positive electrode conductive layer 322, and the material for the positive electrode catalyst layer 323. In either case, the positive electrode layer 32 contains a perovskite type oxide having electrical conductivity and a catalyst that accelerates oxygen reduction reactions, but no carbon. Thus, it is possible to prevent the generation of a carbonate salt of the metal contained in the negative electrode layer 33 on the positive electrode layer 32 during the discharge of the metal-air battery. If the generation of a metal carbonate does not cause any problem, the positive electrode conductive layer 322 may be formed of other conductive materials.

The structure of the above-described metal-air battery may be applied to flat-plate metal-air batteries, for example. In this case as well, local metal deposition on the negative electrode layer during charge can be prevented if the negative electrode opposed face and the auxiliary opposed face are facing each other, and the negative electrode opposed face has portions that extend outwardly from portions facing the edges of the auxiliary opposed face (i.e., portions that extend from portions of the negative electrode opposed face that correspond to the edges of the auxiliary opposed face in the direction of the normal to the two parallel faces, toward the outside in the direction perpendicular to the normal direction). As described above, the metal-air batteries that can prevent the occurrence of a short circuit between the negative electrode layer and the auxiliary electrode layer can be realized in various ways. It is, however, noted that in the case where the positive electrode layer, the negative electrode layer, and the auxiliary electrode layer are cylindrical, the number of edges that become active and at which dendrites are likely to occur can be reduced as compared with the case where the above layers are of flat-plate shapes (i.e., edges exist at only upper and lower ends), and accordingly the occurrence of dendrites can be further suppressed.

The configurations of the above-described preferred embodiments and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

11, 11a to 11d, 21, 21a to 21d, 31 Metal-air battery

12, 22, 22a Positive electrode

13, 23 Negative electrode

14, 16, 24, 26, 311, 312 Electrolyte layer

17, 17a Barrier layer

32 Positive electrode layer

33 Negative electrode layer

34 Auxiliary electrode layer

121, 221 Positive electrode supporter

122, 222, 322 Positive electrode conductive layer

123, 223, 223a, 323 Positive electrode catalyst layer

229 Liquid repellent layer

330 Negative electrode opposed face

340 Auxiliary opposed face

3301, 3302 (Outwardly extending) portion

3401 Upper end portion

3402 Lower end portion

1.-12. (canceled)

13. A metal-air battery comprising:
a negative electrode layer that contains a metal and generates metal ions during discharge;
a porous positive electrode layer that contains a conductive material and a catalyst and generates oxygen ions during discharge, said catalyst accelerating an oxygen reduction reaction;
a first electrolyte layer disposed between said negative electrode layer and said positive electrode layer;
an auxiliary electrode layer having a surface that faces a surface of said negative electrode layer opposite to said positive electrode layer; and
a second electrolyte layer that is disposed between said negative electrode layer and said auxiliary electrode layer and communicates with said first electrolyte layer,
wherein said surface of said negative electrode layer has a portion extending outwardly from a portion facing an edge of said surface of said auxiliary electrode layer, and
said metal is deposited on said negative electrode layer by application of a voltage between said negative electrode layer and said auxiliary electrode layer during charge.

14. The metal-air battery according to claim 13, wherein
said positive electrode layer, said negative electrode layer, and said auxiliary electrode layer are cylindrical, said positive electrode layer is disposed on an inner side of said negative electrode layer and said auxiliary electrode layer is disposed on an outer side of said negative electrode layer.

15. The metal-air battery according to claim 13, wherein
said negative electrode layer is a porous member.

16. The metal-air battery according claim 13, wherein
said conductive material is a perovskite type oxide, and
said positive electrode layer contains no carbon.
